(19) United States
(12) Patent Application Publication
(10) Pub. No.: US 2022/0182691 A1
(43) Pub. Date: Jun. 9, 2022

(54) METHOD AND SYSTEM FOR ENCODING, DECODING AND PLAYBACK OF VIDEO CONTENT IN CLIENT-SERVER ARCHITECTURE

(71) Applicant: Samsung Electronics Co., Ltd., Suwon-si, Gyeonggi-do (KR)

(72) Inventor: Bhaskar JHA, Bangalore (IN)

(21) Appl. No.: 17/603,473

(22) PCT Filed: Apr. 14, 2020
(86) PCT No.: PCT/KR2020/005050

§ 371 Date: Oct. 13, 2021

(30) Foreign Application Priority Data
Apr. 15, 2019 (IN) 201911015094

(51) Int. Cl. H04N 21/234; H04N 19/119; H04N 19/172; H04N 19/14; H04N 19/162; H04N 19/179; H04N 19/25; H04N 19/423; H04N 19/46; H04N 21/239; H04N 21/8547

(52) U.S. Cl. CPC H04N 21/23418; H04N 19/119; H04N 19/172; H04N 19/14; H04N 19/162; H04N 21/8547; H04N 19/25; H04N 19/423; H04N 19/46; H04N 21/2393; H04N 19/179

(57) ABSTRACT

One or more methods and systems are provided for encoding, decoding and playback of a video content in a client-server architecture. The invention proposes a video encoding and decoding method that includes identification of activities in the video content, identification of corresponding API's with related parameters corresponding to activity and storing those API's along with base frame and object frame in the database. In this invention, animation API functions are created for unknown/random activities. The playback involves decoding the data, which is a set of instructions to play the animation with given objects and base frames, and animating object frame over base frame using said API functions.

### CROSS-REFERENCE TO RELATED APPLICATIONS

This application is a 371 of International Application No. PCT/KR2020/005050, filed Apr. 14, 2020, which claims priority to Indian Patent Application No. 201911015094, filed Apr. 15, 2019, the disclosures of which are herein incorporated by reference in their entirety

### BACKGROUND

### 1. Field

The present invention relates generally to animation based encoding, decoding and playback of a video content, and, particularly but not exclusively, to a method and system for animation based encoding, decoding and playback of a video content in an architecture.

### 2. Description of Related Art

Digital video communication is a rapidly developing field especially with the progress made in video coding techniques. This progress has led to a high number of video applications, such as High-Definition Television (HDTV), videoconferencing and real-time video transmission over multimedia. Due to the advent of multimedia computing, the demand for these videos has increased, their storage and manipulation in their raw form is very expensive and it significantly increases the transmission time and makes storage costly. Also, the video file which is stored in form of simple digital chunk is very less informative for the machine to understand. Also, the existing video processing algorithms do not have a maintained standard defining which algorithm to use when. Also, the video search engines contemporarily are mostly based on manual data fed in the metadata part which leads to a very limited search space.

For example, Chinese Patent Application CN106210612A discloses about a video coding method and device, and a video decoding method and device. The video coding device comprises a video collection unit which is used for collecting video images; a processing unit which is used for carrying out compression coding on background images in the video images, thereby obtaining video compression data, and carrying out structuring on foreground moving targets in the video images, thereby obtaining foreground target metadata; and a data transmission unit which is used for transmitting the video compression data and the foreground target metadata, wherein the foreground target metadata is the data in which video structured semantic information is stored. This invention provides a method to compress a video with the video details obtained in form of objects and background and the action with the timestamp and location details.

Another United States Patent Application US20100156911A1 discloses about a method wherein a request may be received to trigger an animation action in response to reaching a bookmark during playback of a media object. In response to the request, data is stored defining a new animation timeline configured to perform the animation action when playback of the media object reaches the bookmark. When the media object is played back, a determination is made as to whether the bookmark has been encountered. If the bookmark is encountered, the new animation timeline is started, thereby triggering the specified animation action. An animation action may also be added to an animation timeline that triggers a media object action at a location within a media object. When the animation action is encountered during playback of the animation timeline, the specified media object action is performed on the associated media object. This invention discloses that the animation event is triggered when reaching a bookmark or a point of interest.

Another European Patent Application EP1452037B1 discloses about a video coding and decoding method, wherein a picture is first divided into sub-pictures corresponding to one or more subjectively important picture regions and to a background region sub-picture, which remains after the other sub-pictures are removed from the picture. The sub-pictures are formed to conform to predetermined allowable groups of video coding macroblocks MBs. The allowable groups of MBs can be, for example, of rectangular shape. The picture is then divided into slices so that each sub-picture is encoded independent of other sub-pictures except for the background region sub-picture, which may be coded using another sub-pictures. The slices of the background sub-picture are formed in a scan-order with skipping over MBs that belong to another sub/picture. The background sub-picture is only decoded if all the positions and sizes of all other sub-pictures can be reconstructed on decoding the picture.

Another European Patent Application EP1492351A1 discloses about true-colour images that are transmitted in ITV systems by disassembling an image frame into background and foreground image elements, and providing background and foreground image elements that are changed in respect to background and foreground image elements of a preceding image frame to a data carousel generator and/or a data server. These true-colour images are received in ITV systems by receiving background and foreground image elements that are changed in respect to received background and foreground image elements of a preceding image frame from a data carousel decoder and/or a data server, and assembling an image frame from the received background and foreground image elements.

### SUMMARY

In view of the above deficiencies mentioned in the conventional approaches, there is a need to have a technical solution to ameliorate said one or more deficiencies or to at least provide a solution to change the way a video is stored to make it more understandable to the machine, as well as reduce the video size and the transmission bandwidth. Hence, there is a need of a video compression technique that helps in reducing the number of bits required to represent a digital video data while maintaining an acceptable video quality.

This summary is provided to introduce concepts related to a method and system for animation based encoding, decoding and playback of a video content in an architecture. The invention, more particularly, relates to animating actions on the video content while playback after decoding the encoded video content, wherein a video compression, decompression and playback technique is used to save bandwidth and storage for the video content. This summary is neither intended to identify essential features of the present invention nor is it intended for use in determining or limiting the scope of the present invention.

For example, various embodiments herein may include one or more methods and systems for animation based encoding, decoding and playback of a video content in a client-server architecture. In one of the implementations, the method includes processing the video content for dividing the video content into a plurality of parts based on one or more category of instructions. Further, the method includes detecting one or more object frames and a base frame from the plurality of parts of the video based on one or more related parameters. The one or more related parameters includes physical and behavioural nature of the relevant object, action performed by the relevant object, speed, angle and orientation of the relevant object, time and location of the plurality of activities and the like. Further, the detected object frame and the base frame are segregated from the plurality of parts of the video based on the related parameters. Further, detecting a plurality of activities in the object frame and storing the object frame, the base frame, the plurality of activities and the related parameters in a second database. The method further includes identifying and mapping a plurality of API's corresponding to the plurality of activities based on the related parameters. Further, a request for playback of the video content is received from one of a plurality of client devices. Here, the plurality of client devices includes smartphones, tablet computer, web interface, camcorder and the like. Upon receiving a request for playback of the video content, the plurality of activities with the object frame and the base frame are merged together for outputting a formatted video playback based on the related parameters.

In another implementation, the method includes capturing the video content for playback. Further, the method includes processing the captured video content for dividing the video content into a plurality of parts based on one or more category of instructions. Further, the method includes detecting one or more object frames and a base frame from the plurality of parts of the video based on one or more related parameters. Further, the detected object frame and the base frame are segregated from the plurality of parts of the video based on the related parameters. Further, detecting a plurality of activities in the object frame and storing the object frame, the base frame, the plurality of activities and the related parameters in a second database. The method further includes identifying and mapping a plurality of API's corresponding to the plurality of activities based on the related parameters. Further, the method includes merging the plurality of activities with the object frame and the base frame together for outputting a formatted video playback based on the related parameters.

In another implementation, the method includes receiving a request for playback of the video content from one of a plurality of client devices. Further, the method includes processing the received video content for dividing the video content into a plurality of parts based on one or more category of instructions. Further, the method includes detecting one or more object frames and a base frame from the plurality of parts of the video based on one or more related parameters. Further, the detected object frame and the base frame are segregated from the plurality of parts of the video based on the related parameters. Further, detecting a plurality of activities in the object frame and storing the object frame, the base frame, the plurality of activities and the related parameters in a second database. The method further includes identifying and mapping a plurality of API's corresponding to the plurality of activities based on the related parameters. Further, the method includes merging the plurality of activities with the object frame and the base frame together for outputting a formatted video playback based on the related parameters.

In another implementation, the method includes sending a request for playback of video content to the server. Further, the method includes receiving from the server one or more object frames, a base frame, plurality of API's corresponding to a plurality of activities and one or more related parameters. Furthermore, the method includes merging the object frames and the base frame with the corresponding plurality of activities associated with the plurality of API's and playing the merged video.

In another implementation, the system includes a video processor module configured to process the video content to divide the video content into a plurality of parts based on one or more category of instructions. Further, the system includes an object and base frame detection module which is configured to detect one or more object frames and a base frame from the plurality of parts of the video based on one or more related parameters. Further, an object and base frame segregation module is configured to segregate the object frame and the base frame from the plurality of parts of the video based on the related parameters. Further, an activity detection module is configured to detect a plurality of activities in the object frame. Furthermore, the system includes a second database stores the object frame, the base frame, the plurality of activities and the related parameters. The system further includes an activity updating module which is configured to identify a plurality of API's corresponding to the plurality of activities based on the related parameters and to map a plurality of API's corresponding to the plurality of activities based on the related parameters. Further, the system includes a server which is configured to receive a request for playback of the video content from one of a plurality of client devices. Further, the system includes an animator module which is configured to merge the plurality of activities with the object frame and the base frame for outputting a formatted video playback based on the related parameters.

The various embodiments of the present disclosure provides a method and system for animation based encoding, decoding and playback of a video content in a client-server architecture. The invention, more particularly, relates to animating actions on the video content while playback after decoding the encoded video content, wherein a video compression, decompression and playback technique is used to save bandwidth and storage for the video content.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates system for animation based encoding, decoding and playback of a video content in a client-server architecture, according to an exemplary implementation of the presently claimed subject matter.

FIG. 2 illustrates the working of the video processor module, according to an exemplary implementation of the presently claimed subject matter.

FIG. 3 illustrates the working of the activity updating module, according to an exemplary implementation of the presently claimed subject matter.

FIG. 4 illustrates the working of the animator module, according to an exemplary implementation of the presently claimed subject matter.

FIG. 5 illustrates a server client architecture with client streaming server video, according to an exemplary implementation of the presently claimed subject matter.

FIG. 6 illustrates an on-camera architecture for animation based encoding, decoding and playback of a video content, according to an exemplary implementation of the presently claimed subject matter.

FIG. 7 illustrates a standalone architecture for animation based encoding, decoding and playback of a video content, according to an exemplary implementation of the presently claimed subject matter.

FIG. 8 illustrates a device architecture for animation based encoding, decoding and playback of a video content, according to an exemplary implementation of the presently claimed subject matter.

FIG. 9(a) illustrates an input framed video of a video content, according to an exemplary implementation of the presently claimed subject matter.

FIG. 9(b) illustrates a background frame of the intermediate segregated output of the video content, according to an exemplary implementation of the presently claimed subject matter.

FIG. 9(c) illustrates an identified actor of the intermediate segregated output of the video content, according to an exemplary implementation of the presently claimed subject matter.

FIG. 9(d) illustrates the action of the intermediate segregated output of the video content, according to an exemplary implementation of the presently claimed subject matter.

FIG. 9(e) illustrates an animated video format output of the video content, according to an exemplary implementation of the presently claimed subject matter.

FIG. 10 illustrates the detection of the type of scene from the plurality of video scenes, according to an exemplary implementation of the presently claimed subject matter.

FIG. 11 illustrates the partition of a video and assignment of the part of the video to the server for processing, according to an exemplary implementation of the presently claimed subject matter.

FIG. 12(a) illustrates the detection of the object frame and the base frame from the part of the video, according to an exemplary implementation of the presently claimed subject matter.

FIG. 12(b) illustrates the segregated base frame from the part of the video, according to an exemplary implementation of the presently claimed subject matter.

FIG. 12(c) illustrates the segregated object frame from the part of the video, according to an exemplary implementation of the presently claimed subject matter.

FIG. 13 illustrates the activity detection of the object frame from the part of the video, according to an exemplary implementation of the presently claimed subject matter.

FIG. 14(a) illustrates the basic flow of the processing of the input video signal, according to an exemplary implementation of the presently claimed subject matter.

FIG. 14(b) illustrates the basic flow of the processing of the input video signal, according to an exemplary implementation of the presently claimed subject matter.

FIG. 14(c) illustrates the basic flow of the processing of the input video signal, according to an exemplary implementation of the presently claimed subject matter.

FIG. 14(d) illustrates the basic flow of the processing of the input video signal, according to an exemplary implementation of the presently claimed subject matter.

FIG. 14(e) illustrates the basic flow of the processing of the input video signal, according to an exemplary implementation of the presently claimed subject matter.

FIG. 14(f) illustrates the basic flow of the processing of the input video signal, according to an exemplary implementation of the presently claimed subject matter.

FIG. 15 is a flowchart illustrating a method for animation based encoding, decoding and playback of a video content in a client-server architecture, according to an exemplary implementation of the presently claimed subject matter.

FIG. 16(a) illustrates the creation of action function by analysing the change of the object over the background frame in the video, according to an exemplary implementation of the presently claimed subject matter.

FIG. 16(b) illustrates the creation of action function by analysing the change of the object over the background frame in the video, according to an exemplary implementation of the presently claimed subject matter.

FIG. 16(c) illustrates the creation of action function by analysing the change of the object over the background frame in the video, according to an exemplary implementation of the presently claimed subject matter.

FIG. 16(d) illustrates the creation of action function by analysing the change of the object over the background frame in the video, according to an exemplary implementation of the presently claimed subject matter.

FIG. 16(e) illustrates the creation of action function by analysing the change of the object over the background frame in the video, according to an exemplary implementation of the presently claimed subject matter.

FIG. 16(f) illustrates the creation of action function by analysing the change of the object over the background frame in the video, according to an exemplary implementation of the presently claimed subject matter.

FIG. 16(g) illustrates the creation of action function by analysing the change of the object over the background frame in the video, according to an exemplary implementation of the presently claimed subject matter.

FIG. 16(h) illustrates the creation of action function by analysing the change of the object over the background frame in the video, according to an exemplary implementation of the presently claimed subject matter.

FIG. 16(i) illustrates the creation of action function by analysing the change of the object over the background frame in the video, according to an exemplary implementation of the presently claimed subject matter.

FIG. 16(j) illustrates the creation of action function by analysing the change of the object over the background frame in the video, according to an exemplary implementation of the presently claimed subject matter.

FIG. 16(k) illustrates the creation of action function by analysing the change of the object over the background frame in the video, according to an exemplary implementation of the presently claimed subject matter.

FIG. 17(a) is a pictorial implementation illustrating the detection of the object frame and the background frame, according to an exemplary implementation of the invention.

FIG. 17(b) is a pictorial implementation illustrating the segregation of the object frame and the background frame, according to an exemplary implementation of the invention.

FIG. 17(c) is a pictorial implementation illustrating the timestamping of the plurality of activities, according to an exemplary implementation of the invention.

FIG. 17(d) is a pictorial implementation illustrating the detection of the location of the plurality of activities, according to an exemplary implementation of the invention.

FIG. 17(e) is a pictorial implementation illustrating the merging of the plurality of activities with the object frame and the base frame for outputting a formatted video playback, according to an exemplary implementation of the invention.

FIG. 18(a) is a pictorial implementation illustrating the detection of the object frame and the background frame, according to an exemplary implementation of the invention.

FIG. 18(b) is a pictorial implementation illustrating the segregation of the object frame and the background frame, according to an exemplary implementation of the invention.

FIG. 18(c) is a pictorial implementation illustrating the timestamping of the plurality of activities, according to an exemplary implementation of the invention.

FIG. 18(d) is a pictorial implementation illustrating the detection of the location of the plurality of activities, according to an exemplary implementation of the invention.

FIG. 18(e) is a pictorial implementation illustrating the merging of the plurality of activities with the object frame and the base frame for outputting a formatted video playback, according to an exemplary implementation of the invention.

FIGS. 19(a), 19(b) and 19(c) is a pictorial implementation that illustrates the identifying of a cast description in the video content, according to an exemplary implementation of the invention.

FIG. 20(a) is a pictorial implementation illustrating the detection of a new action in the video content, according to an exemplary implementation of the invention.

FIG. 20(b) is a pictorial implementation that illustrates the obtaining of animation from the detected new action in the video content, according to an exemplary implementation of the invention.

FIG. 21 is a pictorial implementation of a used case illustrating the editing of a video with relevance to a new changed object, according to an exemplary implementation of the invention.

FIG. 22 is a pictorial implementation of a used case illustrating a trailer making from a whole movie clip, according to an exemplary implementation of the invention.

FIG. 23 is a pictorial implementation of a used case illustrating the processing of detected activities by an electronic device, according to an exemplary implementation of the invention.

FIG. 24(a) is a pictorial implementation of a used case illustrating the frame by frame processing of a panoramic video, according to an exemplary implementation of the invention.

FIG. 24(b) is a pictorial implementation of a used case illustrating the frame by frame processing of a 3D video, according to an exemplary implementation of the invention.

FIG. 25(a) is a pictorial implementation illustrating the video search engine based on video activity database, according to an exemplary implementation of the invention.

FIG. 25(b) is a pictorial implementation illustrating an advanced video search engine, according to an exemplary implementation of the invention.

FIG. 26(a) is a pictorial implementation of a used case illustrating the usage of the proposed system on a Large Format Display (LFD), according to an exemplary implementation of the invention.

FIG. 26(b) is a pictorial implementation of a used case illustrating a LFD displaying an interactive advertisement, according to an exemplary implementation of the invention.

It should be appreciated by those skilled in the art that any block diagrams herein represent conceptual views of illustrative systems embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

The various embodiments of the present disclosure provides a method and system for animation based encoding, decoding and playback of a video content in a client-server architecture. The invention, more particularly, relates to animating actions on the video content while playback after decoding the encoded video content, wherein a video compression, decompression and playback technique is used to save bandwidth and storage for the video content.

In the following description, for purpose of explanation, specific details are set forth in order to provide an understanding of the present claimed subject matter. It will be apparent, however, to one skilled in the art that the present claimed subject matter may be practiced without these details. One skilled in the art will recognize that embodiments of the present claimed subject matter, some of which are described below, may be incorporated into a number of systems.

However, the methods and systems are not limited to the specific embodiments described herein. Further, structures and devices shown in the figures are illustrative of exemplary embodiments of the present claimed subject matter and are meant to avoid obscuring of the present claimed subject matter.

Furthermore, connections between components and/or modules within the figures are not intended to be limited to direct connections. Rather, these components and modules may be modified, re-formatted or otherwise changed by intermediary components and modules.

The present claimed subject matter provides an improved method and system for animation based encoding, decoding and playback of a video content in a client-server architecture.

Various embodiments herein may include one or more methods and systems for animation based encoding, decoding and playback of a video content in a client-server architecture. In one of the embodiments, the video content is processed for dividing the video content into a plurality of parts based on one or more category of instructions. Further, one or more object frames and a base frame are detected from the plurality of parts of the video based on one or more related parameters. The one or more related parameters includes physical and behavioural nature of the relevant object, action performed by the relevant object, speed, angle and orientation of the relevant object, time and location of the plurality of activities and the like. Further, the detected object frame and the base frame are segregated from the plurality of parts of the video based on the related parameters. Further, a plurality of activities are detected in the object frame and the object frame, the base frame, the plurality of activities and the related parameters are stored in a second database. Further, a plurality of API's corresponding to the plurality of activities are identified and mapped based on the related parameters. Further, a request for playback of the video content is received from one of a plurality of client devices. Here, the plurality of client devices includes smartphones, tablet computer, web interface, camcorder and the like. Upon receiving a request for playback of the video content, the plurality of activities with the object frame and the base frame are merged together for outputting a formatted video playback based on the related parameters.

In another embodiment, the video content is captured for playback. Further, the captured video content is processed for dividing the video content into a plurality of parts based on one or more category of instructions. Further, one or more object frames and a base frame are detected from the plurality of parts of the video based on one or more related parameters. Further, the detected object frame and the base frame are segregated from the plurality of parts of the video based on the related parameters. Further, a plurality of activities are detected in the object frame and the object frame, the base frame, the plurality of activities and the related parameters are stored in a second database. Further, a plurality of API's corresponding to the plurality of activities are identified and mapped based on the related parameters. Further, the plurality of activities are merged with the object frame and the base frame together for outputting a formatted video playback based on the related parameters.

In another embodiment, a request is received for playback of the video content from one of a plurality of client devices. Further, the received video content is processed for dividing the video content into a plurality of parts based on one or more category of instructions. Further, one or more object frames and a base frame are detected from the plurality of parts of the video based on one or more related parameters. Further, the detected object frame and the base frame are segregated from the plurality of parts of the video based on the related parameters. Further, a plurality of activities are detected in the object frame and the object frame, the base frame, the plurality of activities and the related parameters are stored in a second database. Further, a plurality of API's corresponding to the plurality of activities are identified and mapped based on the related parameters. Further, the plurality of activities are merged with the object frame and the base frame together for outputting a formatted video playback based on the related parameters.

In another embodiment, a video player is configured to send a request for playback of video content to the server. Further, one or more object frames, a base frame, plurality of API's corresponding to a plurality of activities and one or more related parameters are received from the server. Furthermore, the object frames and the base frame are merged with the corresponding plurality of activities associated with the plurality of API's and the video player is further configured to play the merged video.

In another embodiment, the video player is further configured to download one or more object frames, the base frame, the plurality of API's corresponding to the plurality of activities and one or more related parameters and to store one or more object frames, the base frame, the plurality of API's corresponding to the plurality of activities and one or more related parameters. The video player which is configured to play the merged video further creates buffer of the merged video and the downloaded video.

In another embodiment, a video processor module is configured to process the video content to divide the video content into a plurality of parts based on one or more category of instructions. Further, an object and base frame detection module is configured to detect one or more object frames and a base frame from the plurality of parts of the video based on one or more related parameters. Further, an object and base frame segregation module is configured to segregate the object frame and the base frame from the plurality of parts of the video based on the related parameters. Further, an activity detection module is configured to detect a plurality of activities in the object frame. Furthermore, a second database is configured to store the object frame, the base frame, the plurality of activities and the related parameters. Further, an activity updating module is configured to identify a plurality of API's corresponding to the plurality of activities based on the related parameters and to map a plurality of API's corresponding to the plurality of activities based on the related parameters. Further, a server is configured to receive a request for playback of the video content from one of a plurality of client devices. Further, an animator module is configured to merge the plurality of activities with the object frame and the base frame for outputting a formatted video playback based on the related parameters.

In another embodiment, the object frame and the base frame are stored in the form of an image and the plurality of activities are stored in the form of an action with the location and the timestamp.

In another embodiment, the video content is processed for dividing said video content into a plurality of parts based on one or more category of instructions, wherein the received video content is processed by the video processor module. Further, one or more types of the video content are detected and one or more category of instructions are applied on the type of the video content by a first database. The video content is then divided into a plurality of parts based on the one or more category of instructions from the first database.

In another embodiment, a plurality of unknown activities are identified by the activity updating module. A plurality of API's are created for the plurality of unknown activities by the activity updating module. These created plurality of API's are mapped with the plurality of unknown activities. Moreover, the created plurality of API's for the plurality of unknown activities are updated in a third database.

In another embodiment, the related parameters of the object frames are extracted from the video content.

In another embodiment, the plurality of unknown activities that are identified by the activity updating module further comprises detecting the plurality of API's corresponding to the plurality of activities in the third database and segregating the plurality of activities from the plurality of unknown activities by the activity updating module.

In another embodiment, a foreign object and a relevant object from the object frame are detected by an object segregation module.

In another embodiment, the plurality of activities that are irrelevant in the video content are segregated by an activity segregation module.

In another embodiment, a plurality of timestamps corresponding to the plurality of activities are stored by a timestamp module. Further, a plurality of location details and the orientation of the relevant object corresponding to the plurality of activities are stored by an object locating module. A plurality of data tables are generated based on the timestamp and location information and stored by a files generation module.

In another embodiment, the location is a set of coordinates corresponding to the plurality of activities. And the plurality of timestamps are corresponding to start and end of the plurality of activities with respect to the location.

In another embodiment, an additional information corresponding to the object frame is stored in the second database. Further, an interaction input is detected on the object frame during playback of the video content and the additional information along with the object frame is displayed.

In another embodiment, the first database is a video processing cloud and the video processing cloud further provides instructions related to the detecting of the scene from the plurality of parts of the video to the video processor module and determines the instructions for providing to each of the plurality of parts of the video. Further, each of the plurality of parts of the video is assigned to the server, wherein said server provides the required instructions and a buffer of instructions are provided for downloading at the server.

In another embodiment, the second database is a storage cloud.

In another embodiment, the third database is an API cloud and the API cloud further stores the plurality of API's and provides the plurality of API's corresponding to the plurality of activities and a buffer of the plurality of API's at the client device.

In another embodiment, the first database, second database and the third database correspond to a single database providing a virtual division among themselves.

In another embodiment, the server is connected with the client and the storage cloud by a server connection module. And the client is connected with the server and the storage cloud by a client connection module.

In another embodiment, a plurality of instructions are generated for video playback corresponding to the object frame, the base frame and the plurality of activities based on the related parameters by a file generation module.

It should be noted that the description merely illustrates the principles of the present invention. It will thus be appreciated that those skilled in the art will be able to devise various arrangements that, although not explicitly described herein, embody the principles of the present invention. Furthermore, all examples recited herein are principally intended expressly to be only for explanatory purposes to help the reader in understanding the principles of the invention and the concepts contributed by the inventor to furthering the art and are to be construed as being without limitation to such specifically recited examples and conditions. Moreover, all statements herein reciting principles, aspects, and embodiments of the invention, as well as specific examples thereof, are intended to encompass equivalents thereof.

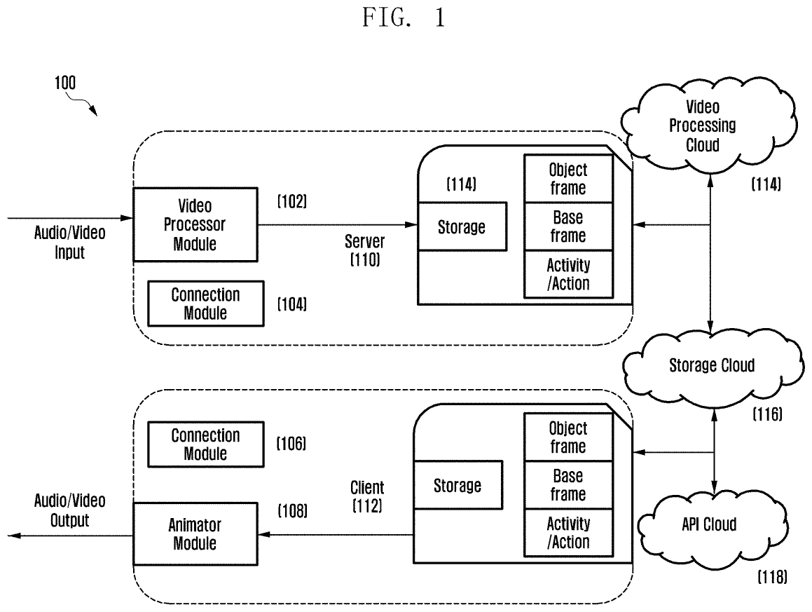

FIG. 1 illustrates system for animation based encoding, decoding and playback of a video content in a client-server architecture, according to an exemplary implementation of the presently claimed subject matter. The system 100 includes various modules, a server 110, a client 112, a storage (120, 122) and various databases. The various modules includes a video processor module 102, a connection module (104, 106) and an animator module 108. The various databases includes a video processing cloud 114, a storage cloud 116, Application Programming Interface (API) cloud 118 and the like.

In the present implementation, the server 108 includes, but are not limited to, a proxy server, a mail server, a web server, an application server, real-time communication server, an FTP server and the like.

In the present implementation, the client devices or user devices include, but are not limited to, mobile phones (for e.g. a smart phone), Personal Digital Assistants (PDAs), smart TVs, wearable devices (for e.g. smart watches and smart bands), tablet computers, Personal Computers (PCs), laptops, display devices, content playing devices, IoT devices, devices on content delivery network (CDN) and the like.

In the present implementation, the system 100 further includes one or more processor(s). The processor may be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in a memory.

In the present implementation, the database may be implemented as, but not limited to, enterprise database, remote database, local database, and the like. Further, the database may themselves be located either within the vicinity of each other or may be located at different geographic locations. Furthermore, the database may be implemented inside or outside the system 100 and the database may be implemented as a single database or a plurality of parallel databases connected to each other and with the system 100 through network. Further, the database may be resided in each of the plurality of client devices, wherein the client 112 as shown in FIG. 1 can be the client device 112.

In the present implementation, the audio/video input is the input source to the video processor module 102. The audio/video input can be an analog video signal or digital video data that is processed and deduced by the video processor module 102. It may also be an existing video format such as .mp4, .avi, and the like.

In the present implementation, the video processing cloud 114 is configured to provide the appropriate algorithm to process a part of the video content. The video processing cloud 114 is configured to provide scene detection algorithms to the video processor module 102. It further divides the video into a plurality of parts or sub frames and determines the algorithm to be used for each of the plurality of parts. Further, the video processing cloud 114 is configured to assign the plurality of parts or sub frames to the video processing server 110 that provides the appropriate algorithms to deduce about the object frame, base frame and plurality of activities of the video content. Further, the video processing cloud 114 is configured to detect and store a plurality of unknown activities in the form of animation in the API cloud 118. Further, a buffer of algorithms are provided which could be downloaded at the server 110. Further, the video processing cloud 114 is configured to maintain the video processing standards.

In the present implementation, the API cloud 118 is configured to store a plurality of animations that the video processing cloud 114 has processed. It further provides the accurate API as per the activity segregated out by the video processor module 102. The API cloud 118 is further configured to create an optimized and a Graphics Processing Unit (GPU) safe library. It is configured to provide a buffer of API's at the client 112 where the video is played.

In the present implementation, the storage cloud 116 is configured to store the object frame, the base frame and the plurality of activities that are segregated by the video processor module 102. The storage cloud 116 is present between the server 110 and client 112 through the connection module (104, 106). Here, the video processing cloud 114 is a first database, the storage cloud 116 is a second database and the API cloud 117 is a third database. The first database, second database and the third database correspond to a single database providing a virtual division among themselves.

Further, the system 100 includes a video processor module 102, a connection module (104, 106) and an animator module 108. The video processor module 102 is configured to process the analog video input and to segregate the entities which includes the objects also referred to as the object frame, the background frames also referred to as the base frame and the plurality of actions also referred to as the plurality of activities. The video processor module 102 is further configured to store these entities in the animator module 108. The video processor module 102 works in conjunction with the video processing cloud. Further, the conventional algorithms of the video processing techniques are used to deduce about the object frame, base frame and plurality of activities of the video content. Further, the system 100 includes the connection module which includes the server connection module 104 and the client connection module 106. The server connection module 104 is configured to connect the server 110 with the client 112 and the storage cloud 116. It also sends the output of the video processor module 102 to the storage cloud 116. The client connection module 106 is configured to connect the client 112 with the server 110 and the storage cloud 116. It also fetches the output of the video processor module 102 from the storage cloud 116. Further, the system 100 includes the animator module 108 which is configured to merge the plurality of activities with the object frame and the base frame and to animate a video out of it. The animator module 108 is connected to the API cloud 118 which helps it to map the plurality of activities with the animation API. It further works in conjunction with the API cloud 118.

In the present implementation, the system 100 includes the storage which includes the server storage 102 and the client storage 122. The server storage 120 is the storage device at the server side in which the output of the video processor module 102 is stored. The output of the video processor module 102 comes as the object frame, the base frame and the plurality of activities involved. These object frames and the base frames are stored as images and the plurality of activities are stored as action with location and timestamp. Further, the client storage 122 is configured to store the data obtained from the storage cloud 116. The data is the output of the video processor module 102 which comes as the object frame, the base frame and the plurality of activities involved. These object frames and the base frames are stored as images and the plurality of activities are stored as action with location and timestamp.

Further, the audio/video output is obtained using the animator module 108 which is configured to merge the plurality of activities with the object frame and the base frame.

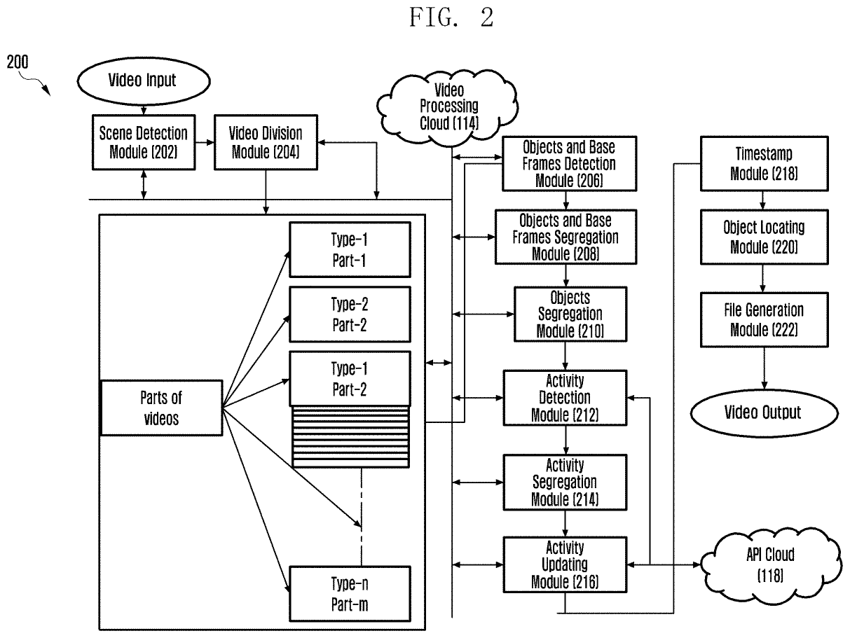

FIG. 2 illustrates the working of the video processor module 102, according to an exemplary implementation of the presently claimed subject matter. The video processor module 102 includes various modules such as a scene detection module 202, a video division module 204, an objects and base frame detection module 206, an objects and base frame segregation module 208, an objects segregation module 210, an activity detection module 212, an activity segregation module 214, an activity updating module 216, a timestamp module 218, an object locating module 220 and a file generation module 222. The video processor module 102 further includes the video processing cloud 114 and the API cloud 118.

Further, the scene detection module 202 is configured to detect the type of algorithm to be used in the video content. Each of the plurality of parts of the video content may need different type of processing algorithm. This scene detection module 202 is configured to detect the algorithm to be used as per the change in the video content. Further, the type of the video is obtained to apply the appropriate processing algorithm. Further, the appropriate algorithms are deployed to detect the type of the scene. The video processing cloud 114 obtains the type of the scene from the scene detection module 202 and then determines from one or more category of instructions to apply as per the relevance of the scene. Further, the video division module 204 is configured to divide the video into a plurality of parts as per the processing algorithm required to proceed. The video can be divided into parts and even sub frames to apply processing and make it available as a video thread for the video processors. Further, many known methods are used for detection of scene changes in a video content, colour change, motion change and the like and automatically splitting the video into separate clips. Once the division of the each of the plurality of parts is completed, said each of the plurality of parts is sent to the video processing cloud 114 where the available server is assigned the tasks to process the video. The video is divided into a plurality of parts as per the video processing algorithm to be used.

Further, the objects and base frames detection module 206 is configured to detect one or more object frames present in the part of the video content. The main three key steps in the analysis of video process are: moving objects detection in video frames, track the detected object or objects from one frame to another and study of tracked object paths to estimate their behaviours. Mathematically every image frame is matrix of order i×j, and the fth image frame be defined as a matrix:

$$f ( m , n , t ) = [ \begin{matrix}f ( 0 , 0 , t ) & f ( 0 , 1 , t ) & … & f ( 0 , j - 1 , t ) \\ f ( 1 , 0 , t ) & f ( 1 , 1 , t ) & … & f ( 1 , j - 1 , t ) \\ ⋮ & ⋮ & ⋱ & ⋮ \\ f ( i - 1 , 0 , t ) & f ( i - 1 , 1 , t ) & … & f ( i - 1 , j - 1 , t )\end{matrix} ]$$

where i and j is the width and height of the image frame respectively. The pixel intensity or gray value at location (m, n) at time t is denoted by (m, n, t). Further, the objects and base frames segregation module 208 is configured to segregate the object frame and the base frame. The fundamental objective of the image segmentation calculations is to partition a picture into comparative areas. Each division calculation normally addresses two issues, to decide criteria based on that segmentation of images is doing and the technique for attaining effective dividing. The various division methods that are used are image segmentation using Graph-Cuts (Normalized cuts), mean shift clustering, active contours and the like. Further, the objects segregation module 210 is configured to detect if the object is relevant to the context. The appropriate machine learning algorithms are used to differentiate a relevant object and a foreign object from the object frame. The present invention discloses characterization of optimal decision rules. If anomalies that are local optimal decision rules are local even when the nominal behaviour exhibits global spatial and temporal statistical dependencies. This helps collapse the large ambient data dimension for detecting local anomalies. Consequently, consistent data-driven local observed rules with provable performance can be derived with limited training data. The observed rules are based on scores functions derived from local nearest neighbour distances. These rules aggregate statistics across spatio-temporal locations & scales, and produce a single composite score for video segments.

Further, the activity detection module 212 is configured to detect the plurality of activities in the video content. The activities can be motion detection, illuminance change detection, colour change detection and the like. In an exemplary implementation, the human activity detection/recognition is provided herein. The human activity recognition can be separated into three levels of representations, individually the low-level core technology, the mid-level human activity recognition systems and the high-level applications. In the first level of core technology, three main processing stages are considered, i.e., object segmentation, feature extraction and representation, and activity detection and classification algorithms. The human object is first segmented out from the video sequence. The characteristics of the human object such as shape, silhouette, colours, poses, and body motions are then properly extracted and represented by a set of features. Subsequently, an activity detection or classification algorithm is applied on the extracted features to recognize the various human activities. Moreover, in the second level of human activity recognition systems, three important recognition systems are discussed including single person activity recognition, multiple people interaction and crowd behaviour, and abnormal activity recognition. Finally, the third level of applications discusses the recognized results applied in surveillance environments, entertainment environments or healthcare systems. In the first stage of the core technology, the object segmentation is performed on each frame in the video sequence to extract the target object. Depending on the mobility of cameras, the object segmentation can be categorized as two types of segmentation, the static camera segmentation and moving camera segmentation. In the second stage of the core technology, characteristics of the segmented objects such as shape, silhouette, colours and motions are extracted and represented in some form of features. The features can be categorized as four groups, space-time information, frequency transform, local descriptors and body modelling. In the third stage of the core technology, the activity detection and classification algorithms are used to recognize various human activities based on the represented features. They can be categorized as dynamic time warping (DTW), generative models, discriminative models and others.

Furthermore, the activity segregation module 214 is configured to segregate the irrelevant activities from a video content. For example, an irrelevant activity can be some insect dancing in front of a CCTV camera. Further, the activity updating module 216 is configured to identify a plurality of unknown activities. Further, the timestamp module 218 is configured to store timestamps of each of the plurality of activities. The time-stamping, time-coding, and spotting are all crucial parts of audio and video workflows, especially for captioning and subtitling services and translation. This refers to the process of adding timing markers also known as timestamps to a transcription. The time-stamps can be added at regular intervals, or when certain events happen in the audio or video file. Usually the time-stamps just contain minutes and seconds, though they can sometimes contain frames or milliseconds as well. Further, the object locating module 220 is to store the location details of the plurality of activities. It can store the motion as start and end point of the motion and curvature of motion. Further, the file generation module 222 is configured to generate a plurality of data tables based on the timestamp and location information. The examples of the data tables generated are as below:

TABLE 1
Activity to animation map

| Activity | Animation API |
|---|---|
| Riding | QueenHorse( ) |
| Travelling | SoldiersTravel( ) |
| Leading | QueenLeading( ) |
| Smiling | Smiling( ) |

TABLE 2
Activity to time map

| Activity | Timestamp |
|---|---|
| Riding | T2 |
| Travelling | T0 |
| Leading | T1 |
| Smiling | T3 |

TABLE 3
Activity to location map

| Activity | start | end | Motion equation |
|---|---|---|---|
| Riding | L1 | L2 | EQ0: Straight |
| | | | line |
| Travelling | L0 | L2 | EQ1: path curve |
| Leading | L3 | L4 | EQ2: random |
| | | | curve |
| Smiling | L5 | L6 | EQ3: smile curve |

Further, the video processor module 102 is configured to output the activity details of the video content as the type of the activity i.e. the activity, who performs the activity i.e. the object, on whom is the activity performed i.e. the base frame, when the activity is performed i.e. the timestamp and where the activity is performed i.e. the location. The output is a formatted video playback based on the related parameters. The related parameters includes physical and behavioural nature of the relevant object, action performed by the relevant object, speed, angle and orientation of the relevant object, time and location of the plurality of activities and the like.

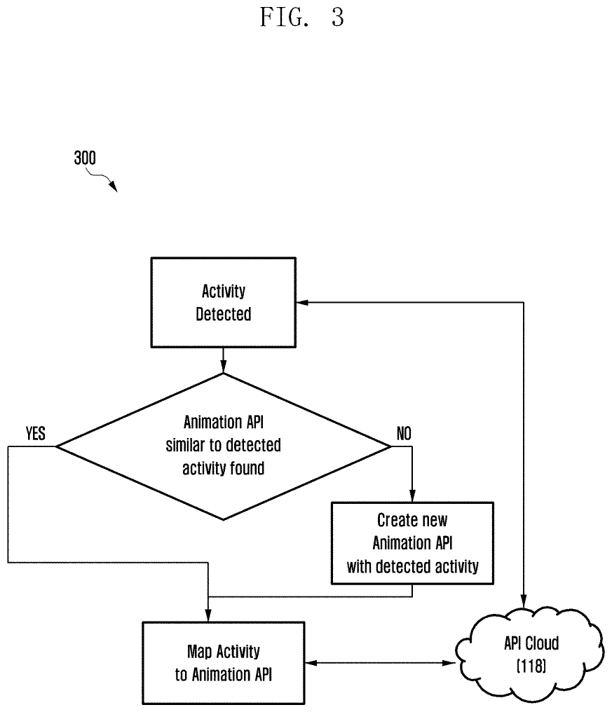

FIG. 3 illustrates the working of the activity updating module, according to an exemplary implementation of the presently claimed subject matter. The activity updating module 216 is configured to identify a plurality of unknown activities. Further, it is configured to detect if the activity's animation API matches with some present API's in the API cloud 118. If the animation API is not present, then the activity updating module 216 creates a plurality of API's for the unknown activities and updates the newly created plurality of API's for the unknown activities in the API cloud 118.

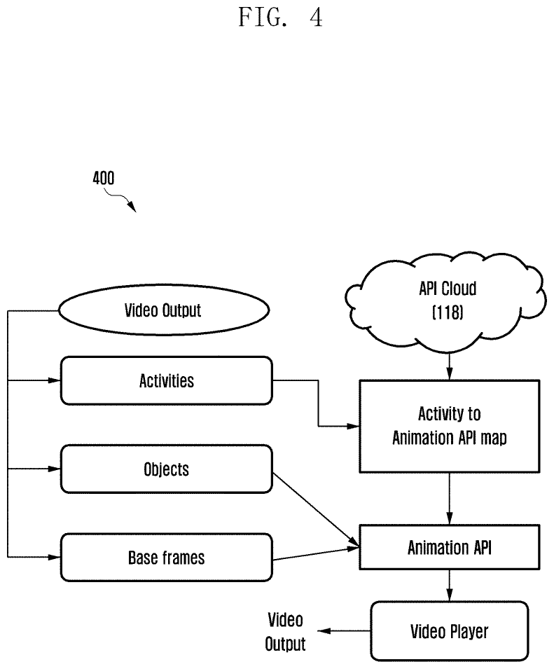

FIG. 4 illustrates the working of the animator module, according to an exemplary implementation of the presently claimed subject matter. The animator module 108 is configured to merge the plurality of activities with the object frame and the base frame and animate a video content out of it. It is connected to the API cloud 118 which is configured to map the plurality of activities with the animation API. For Example, bounce activity of the bowl could be mapped with bounce animation API which will bounce the object(bowl) over the base frame. A player runs this API and gives a visual output. Further, the API cloud 118 is configured to store the plurality of API's that a video processing cloud 114 has processed. Further, the activity to animation API maps the activity to the most similar API using Similarity Function or other similarity rules and the type of activity. This similarity is learned through various similarity modules. Several kinds of optimization can be made to match the API with the most similar one. Here, the mapped animation API is downloaded and initiated at the node to play the animation. The table below is an example of the activity-animation similarity:

TABLE 4
Activity-Animation similarity

| Activity | Animation API | Similarity |
|---|---|---|
| Riding | RideHorse(···) | 0.49 |
| | QueenHorseRide(···) | 0.95 |
| | SoldierHorseRide(···) | 0.68 |
| | KingHorseRide(···) | 0.86 |

Further, the animation API animates the activity that had occurred. It needs basic parameters required for the animation to run. Some examples are shown below:

TABLE 5
Animation Parameters

| Animation API | Parameters |
|---|---|
| RideHorse(···) | Horse speed, Orientation, Angle, turns, |
| | Facing, sitting position etc. |
| BouncingBowl( ) | Speed, angle, orientation, bowl type, no. of |
| | bounces, rotate on bounce, etc. |
| CarMoving(···) | Speed, angle, orientation, tyre angular |
| | speed, etc. |
| Fight( ) | Combat value, no. of punches energy, |
| | movement, etc. |

Further, the player is an application capable of reading the object frame and the base frame and draw activities on and with them so as to give an illusion of a video. It is made up of simple image linkers and animation APIs. It is an application compatible for playback of a video in the format file. Further, the video player provides animation modules which are called with association of one or more objects. Further, the playback buffer is obtained by first downloading the contents which are the data of the plurality of activities, the object frame and the base frame. Then, merging the object frame and the base frame with the plurality of activities associated API's and playing the merged video.

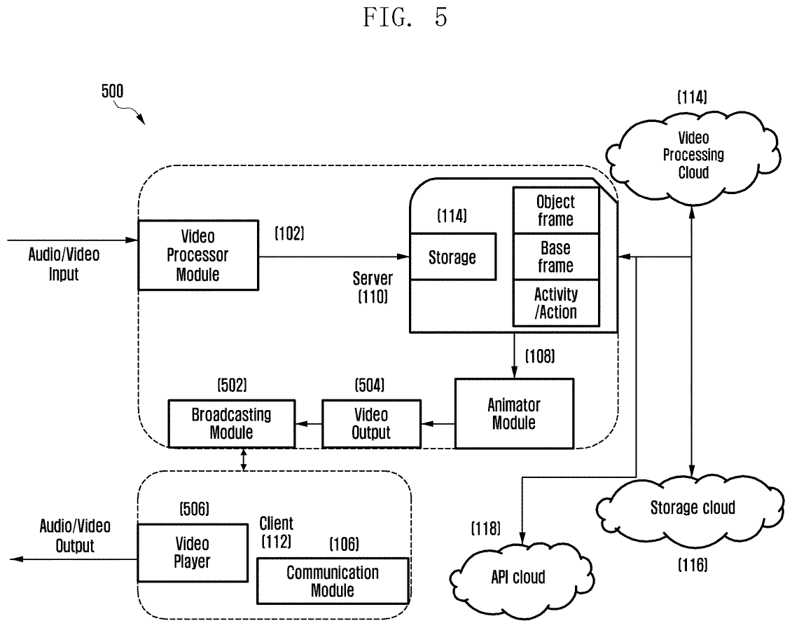

FIG. 5 illustrates a server client architecture with client streaming server video, according to an exemplary implementation of the presently claimed subject matter. This server client architecture provides that both the animation and the video processing can be carried out at the server and the output can be broadcasted live. In this the server processes and animates the video so that it can broadcast it to the client devices. The client just has to play the video using the video player. Further, the output formatted video playback is obtained by using the animator module 108 that merges the plurality of activities with the base frame and the object frame. Further, the broadcasting module 502 is configured to broadcast the media playback of the file as a normal video file. It is present in the server side and it converts a playback to a live stream. Further, the communication module 106 is configured to create an interface between the client 112 and the broadcaster. It passes messages from the client 112 to the broadcaster and also serves the purpose of connection between the server 110 and the client 112. And the video player 506 is present at the client side 112. It has the ability of playback of live streamed videos. Further, an output video is obtained with the playback of the video player 506.

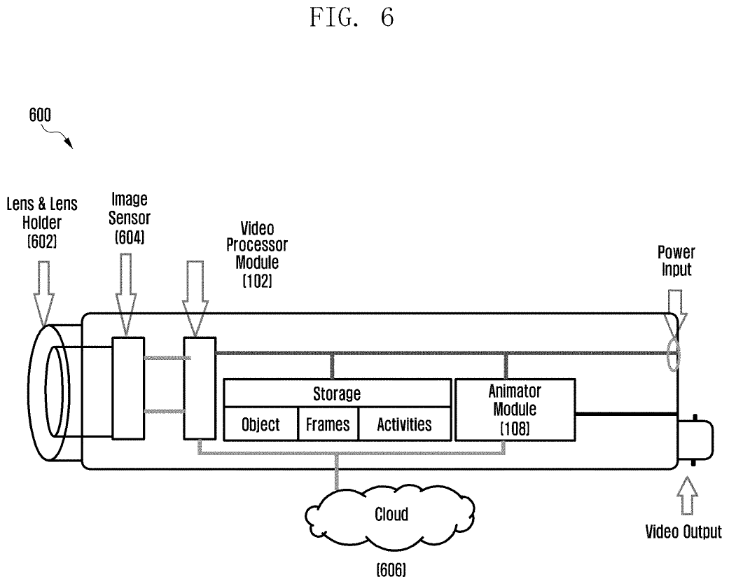

FIG. 6 illustrates an on-camera architecture for animation based encoding, decoding and playback of a video content, according to an exemplary implementation of the presently claimed subject matter. This architecture is established in a capturing device 600 which can be a camera. The camera is configured to connect with the cloud for processing and playing the video. Here, the camera is a standalone system and hence both the video processor module 102 and the animator module 108 are on the camera. Further, the lens 602 is configured to make an image over the light sensitive plate. This refracts light and makes a real image over the image sensor which is then processed as a digital sample. Further, the types of image sensors 604 are CMOS and CCD wherein the CCD has uniform output, thus better image quality and the CMOS sensor, on the other hand, has uniformity much lower, resulting in less image quality. Further, the power source to the camera may be a battery. Here, a capturing device 600 configured to capture the video content for playback and the video processor module 102 is configured to process the captured video content for dividing said video content into a plurality of parts based on one or more category of instructions. Further, the object and base frame detection module 206 is configured to detect one or more object frames and a base frame from the plurality of parts of the video based on one or more related parameters. The object and base frame segregation module 208 is configured to segregate the object frame and the base frame from the plurality of parts of the video based on the related parameters. Further, an activity detection module 212 is configured to detect a plurality of activities in the object frame and the second database is configured to store the object frame, the base frame and the plurality of activities based on the related parameters. Further, the activity updating module 216 is configured to identify a plurality of API's corresponding to the plurality of activities based on the related parameters and to map a plurality of API's corresponding to the plurality of activities based on the related parameters. Further, the animator module 108 is configured to merge the plurality of activities with the object frame and the base frame for outputting a formatted video playback based on the related parameters.

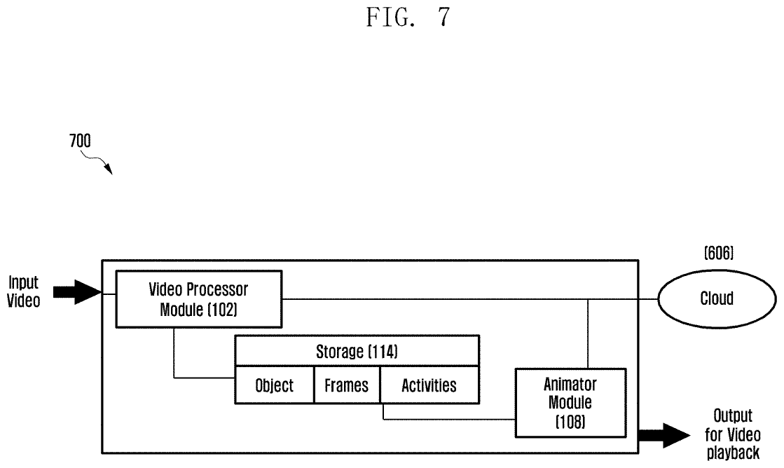

FIG. 7 illustrates a standalone architecture for animation based encoding, decoding and playback of a video content, according to an exemplary implementation of the presently claimed subject matter. In this architecture, the node processes an analogue or digital video present in current formats and generates the object frame, base frame and the plurality of activities and finally animates them to a format playback. This architecture may be present in a simple standalone computer system connected to the cloud 606. Here, the input video is the input source for the video processor module 102. It can be some analog video signal or digital video data that could be processed and deduced by the video processor module 102. It may also be an existing video format like .mp4, .avi, etc.

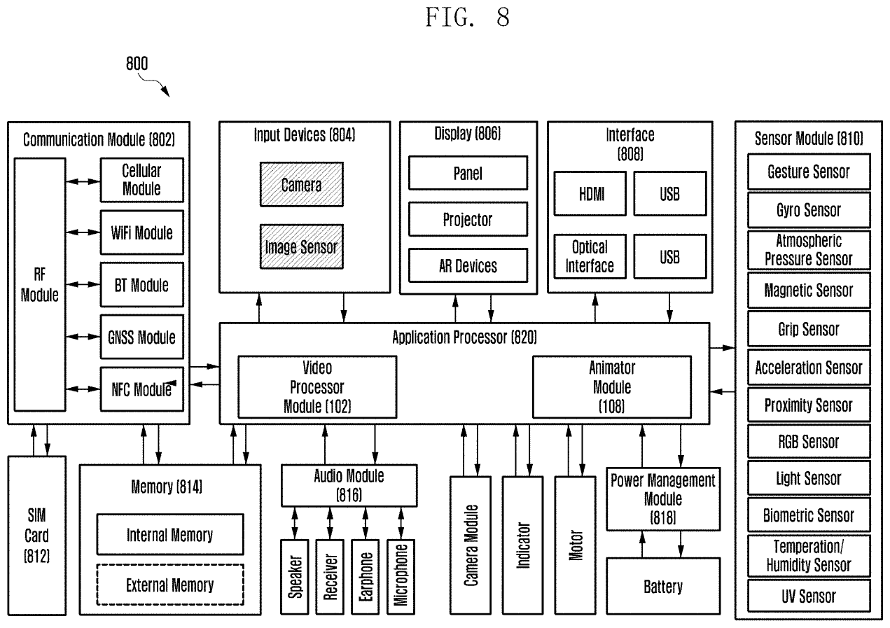

FIG. 8 illustrates a device architecture for animation based encoding, decoding and playback of a video content, according to an exemplary implementation of the presently claimed subject matter. This figure shows the architecture design of the capturing device. The capturing device includes an Application Processor 816 interconnected with a communication module 802, a plurality of input devices 804, a display 806, a user interface 08, a plurality of sensor modules 810, a sim card, a memory 812, an audio module 814, a camera module, an indicator, a motor and a power management module. The communication module further comprises an RF module interconnected with the cellular module, Wi-Fi module, Bluetooth module, GNSS module and a NFC module. The plurality of input devices further comprises a camera and an image sensor. The display further comprises a panel, a projector and AR devices. The user interface can be HDMI, USB, optical interface and the like. Further, the plurality of sensor modules includes a gesture sensor, a gyro sensor, an atmospheric pressure sensor, a magnetic sensor, a grip sensor, an acceleration sensor, a proximity sensor, a RGB sensor, a light sensor, a biometric sensor, a temperature/humidity sensor, an UV sensor and the like. The audio module can be a speaker, a receiver, an earphone, a microphone and the like. The Application Processor (AP) includes a video processor module 102 and an animator module 108. The video processor module is configured to process the video and the animator module is configured to animate the video.

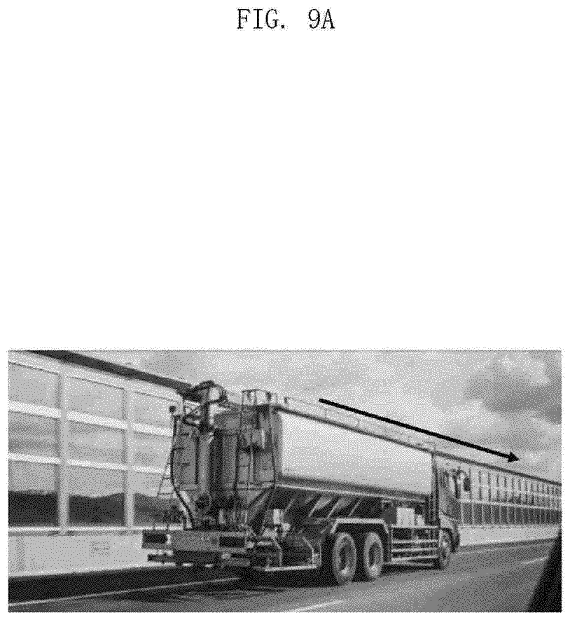

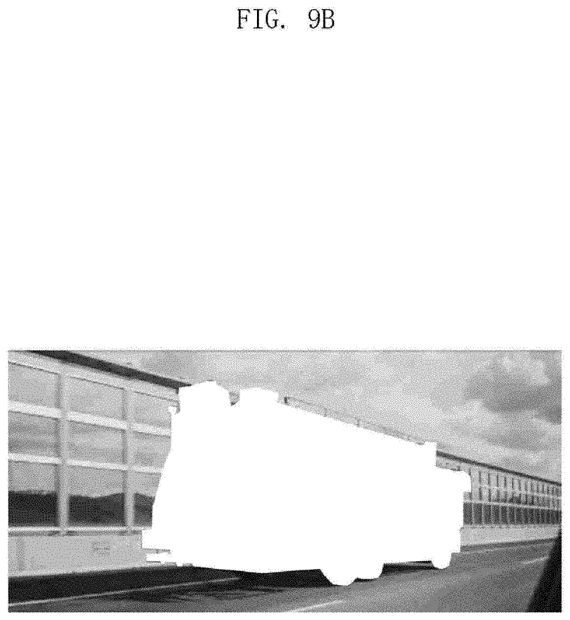

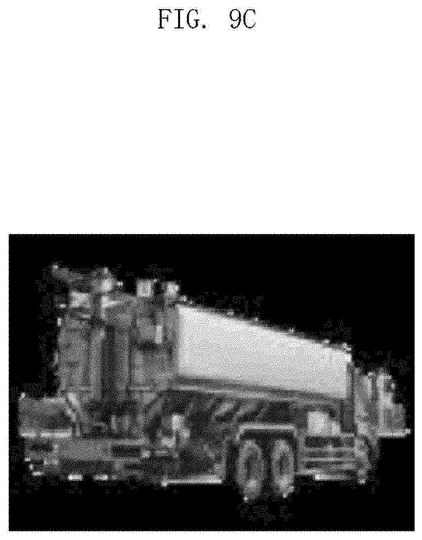

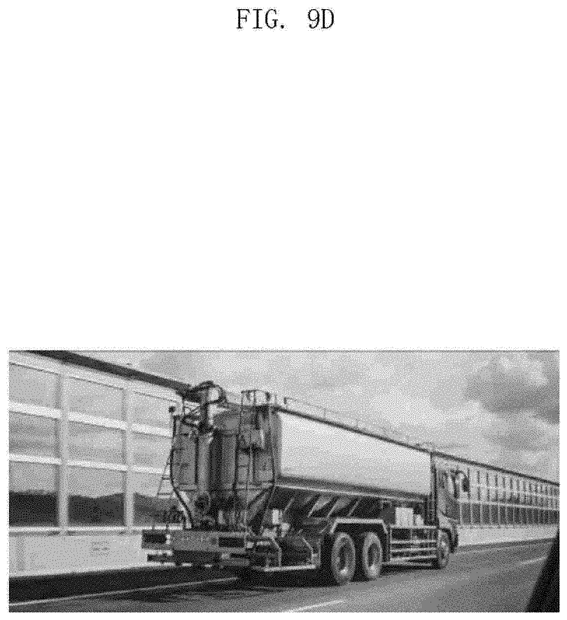

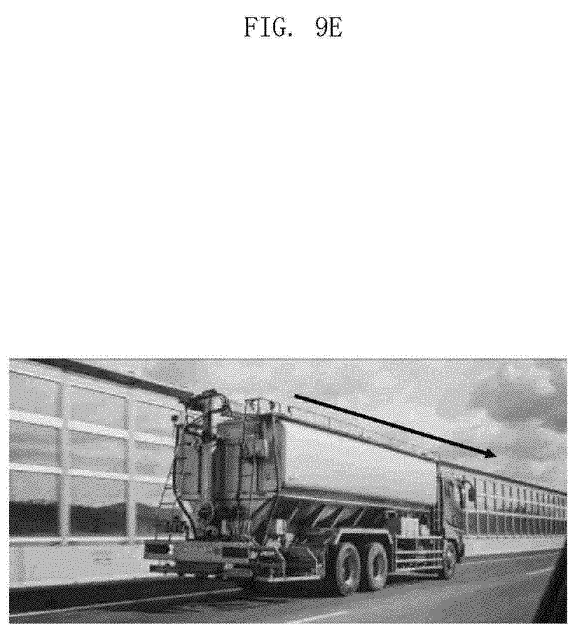

FIG. 9(a) illustrates an input framed video of a video content, according to an exemplary implementation of the presently claimed subject matter. Here, a part of the video content is identified. In this video content, an object frame and a base frame is detected.

FIG. 9(b) illustrates a background frame of the intermediate segregated output of the video content, according to an exemplary implementation of the presently claimed subject matter. FIG. 9(c) illustrates an identified actor of the intermediate segregated output of the video content, according to an exemplary implementation of the presently claimed subject matter. FIG. 9(d) illustrates the action of the intermediate segregated output of the video content, according to an exemplary implementation of the presently claimed subject matter. Here, the object frame and the base frame are segregated and also the activity by the object frame is detected. Further, the API related to the activity is identified and mapped.

FIG. 9(e) illustrates an animated video format output of the video content, according to an exemplary implementation of the presently claimed subject matter. For example, the animated video format output of the video content may be a .vdo format or any other format. Here, a request for playback of the video content is received from one of a plurality of client devices and the plurality of activities are merged with the object frame and the base frame for outputting a formatted video playback based on the related parameters.

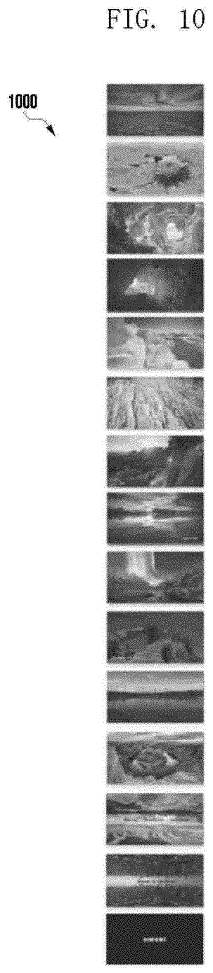

FIG. 10 illustrates the detection of the type of scene from the plurality of video scenes, according to an exemplary implementation of the presently claimed subject matter. In this figure, a plurality of scenes of the video are deduced and the type of the scene is detected from said plurality of scenes.

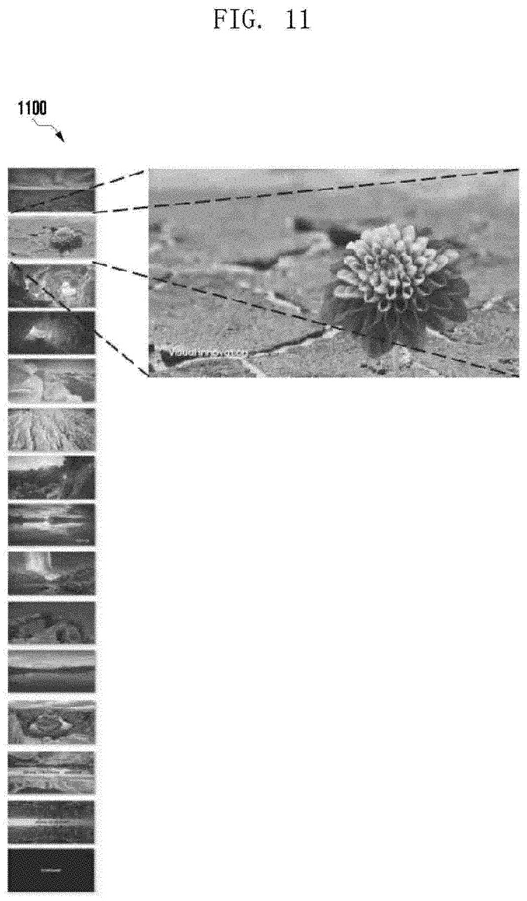

FIG. 11 illustrates the partition of a video and assignment of the part of the video to the server for processing, according to an exemplary implementation of the presently claimed subject matter. In this figure, the video content is divided into a plurality of parts based on the video processing algorithm to be used. Further, each of the plurality of parts of the video is assigned to the server, wherein said server provides the required instructions.

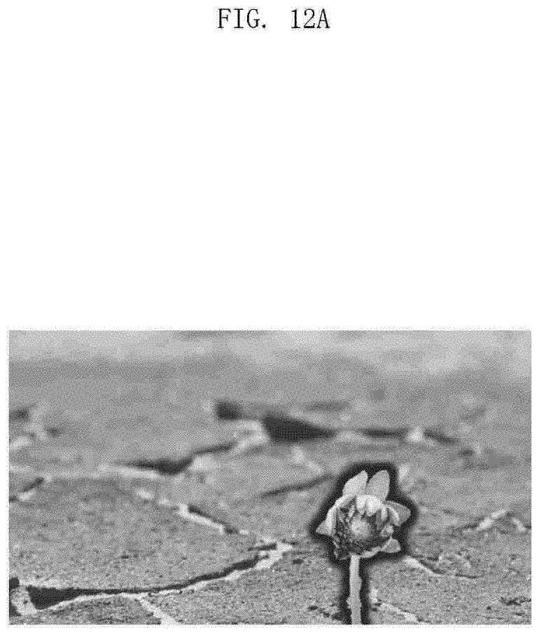

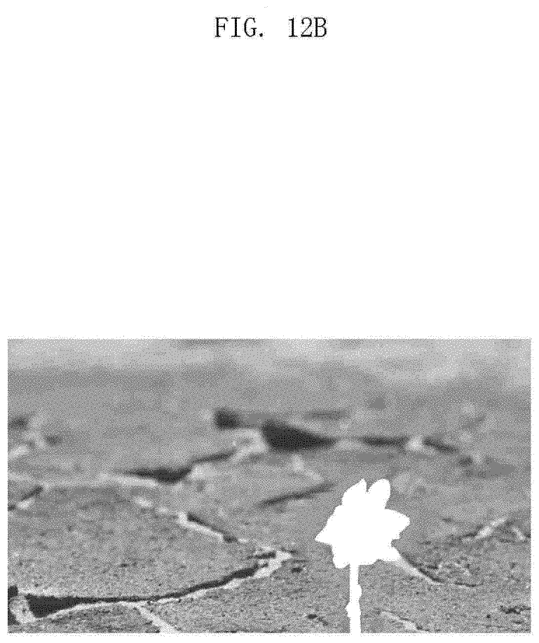

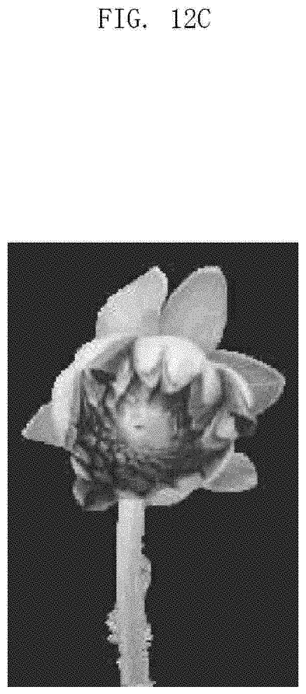

FIG. 12(a) illustrates the detection of the object frame and the base frame from the part of the video, according to an exemplary implementation of the presently claimed subject matter. FIG. 12(b) illustrates the segregated base frame from the part of the video, according to an exemplary implementation of the presently claimed subject matter. FIG. 12(c) illustrates the segregated object frame from the part of the video, according to an exemplary implementation of the presently claimed subject matter. Here, an object and base frame detection module is configured to detect the object frame and the base frame from the part of the video based on one or more related parameters. Further, the object and base frame segregation module is configured to segregate the object frame and the base frame from the part of the video based on the related parameters. In this figure, the flower is the object and soil is the base frame, wherein,

Object Flower=new Object( )

BaseFrame Soil=new BaseFrame( )

Further, as a cactus in this soil is irrelevant to grow. Thus, the object is irrelevant to the context base frame. Thus, cactus would be a foreign object to this soil.

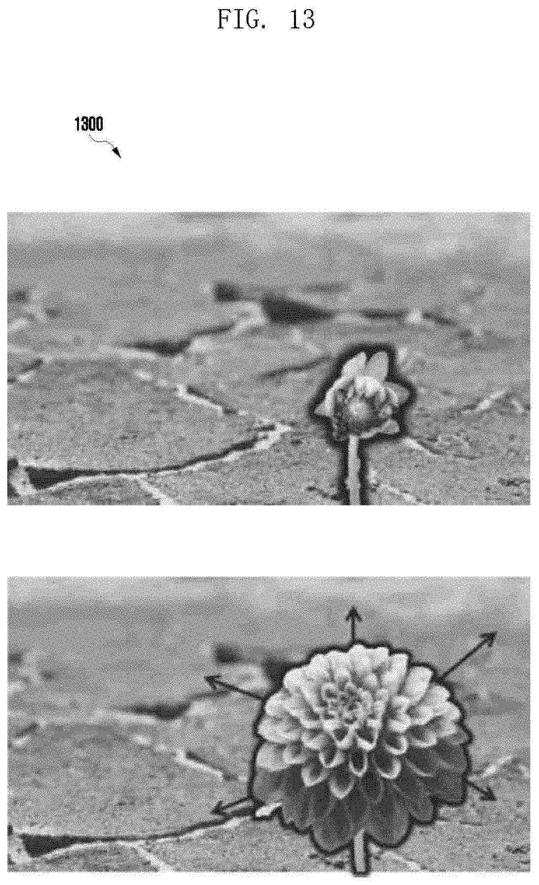

FIG. 13 illustrates the activity detection of the object frame from the part of the video, according to an exemplary implementation of the presently claimed subject matter. Here, the plurality of activities are detected in the object frame. In this figure, the activity is detected based on the timestamp information. At time T1, there is no activity whereas at time T2 there is an activity of the flower blossoming. Further, a flower would blossom in this environment. If the flower does something irrelevant for example, jump, bounce, etc. then this activity of the flower would be irrelevant to the context. Thus activity jump, bounce, etc. is irrelevant and is segregated. Further, an unknown activity is identified by the activity updating module and an API is created for said unknown activity and the created API is mapped with the unknown activity. In this figure, the flower's “Blossom” activity was searched with all Animation APIs in the API Cloud. It matched with F Blossom( . . . ) API. In case, a similar API would not have been found, the animation API would be created from the video. The timestamp table (Table 6) and the location table (Table 7) for the detected scenario is shown below:

TABLE 6
Timestamp Table for detected Scenario

| Activity | Timestamp |
|---|---|
| Planted flower | T0 |
| NONE | T1 |
| Blossom | T2 |

TABLE 7
Location Table for detected Scenario

| Activity | start | Fend | Motion details |
|---|---|---|---|
| Planted flower | L0 | L0 | EQ1: Appear |
| NONE | L0 | L0 | NULL |
| Blossom | L0 | L1 | EQ2: Appear with size |
| | | | change |

Further, a plurality of data tables based on the timestamp and location information as shown below are generated by the file generation module. As the above data tables are generated for the given video scenario, the activity is animated at the given time and the location and with the applicable animation APIs. Further, in this figure, the mapped animation API is downloaded and initiated at the node to play the animation. For example, F Blossom( ) API is downloaded for flower's blossom activity.

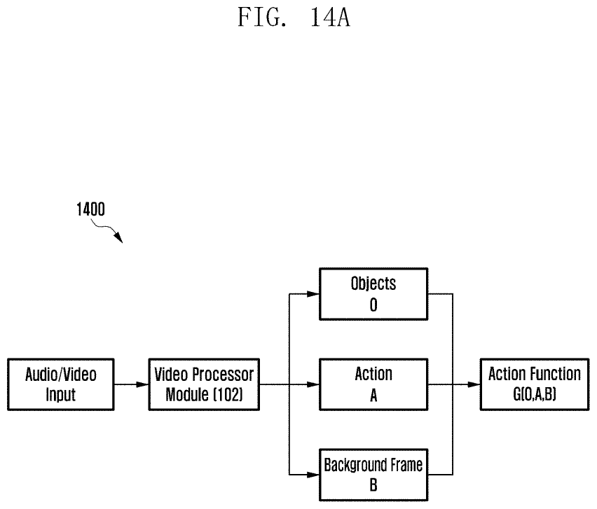

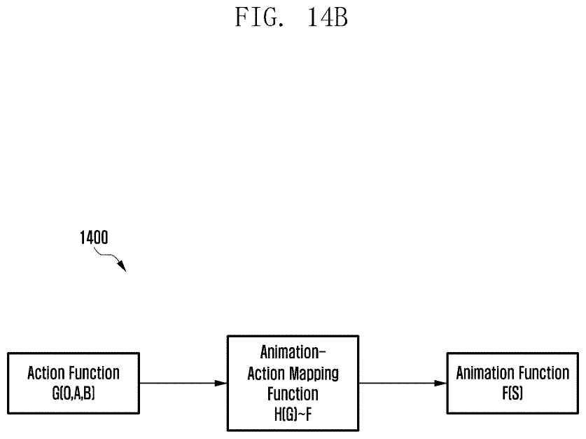

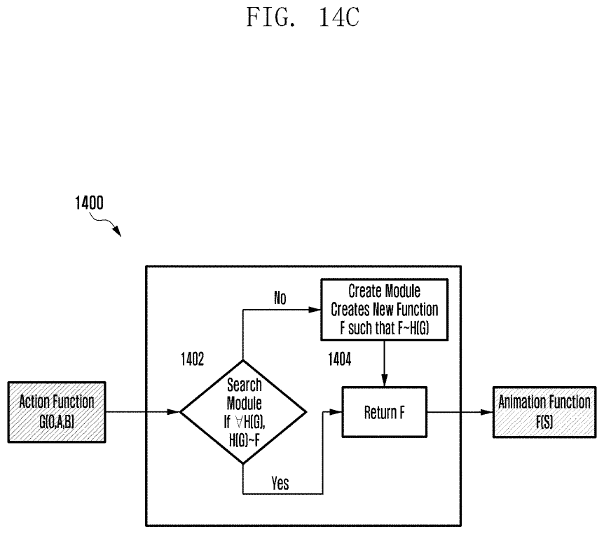

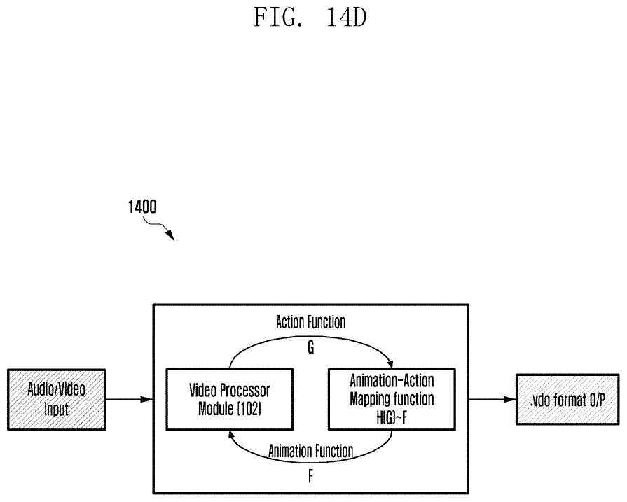

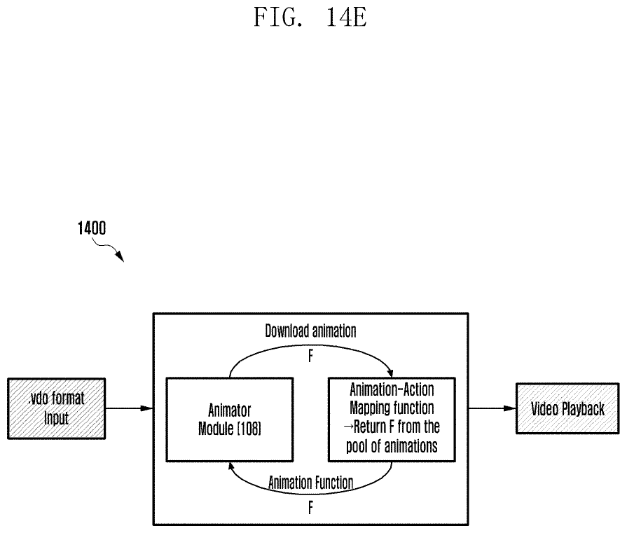

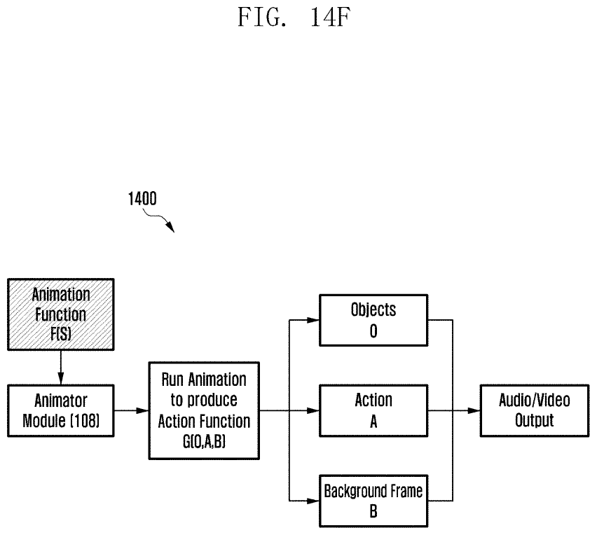

FIGS. 14(a), 14(b), 14(c), 14(d), 14(e) and 14(f) illustrates the basic flow of the processing of the input video signal, according to an exemplary implementation of the presently claimed subject matter. Here, the video content is processed and all the details of the video content are extracted using the video processor module followed by animating these details with the help of the animator module. In an exemplary implementation, the input is an mp4 video in which a car is moving on a highway wherein the video processor module 102 is configured to process the input video signal as shown in FIG. 14(a). The object (O), the background frame(B), and the action(A) are segregated wherein,

O: Set of foreground Objects

B: Set of Background Object

A: Action

Further, the video processor module 102 is configured to generate a function called as an Action function G (O, A, B) which is the function that is obtained after merging the entities O, A and B. thus G(O, A, B) is denoted as follows:

G(O,A,B):MovingCar(Car, Highway, Moving);

Such that,

O: Car

B: Highway

A: Moving

Here, the O, B being the images of the car and the highway, also holds the physical and behavioral data. Thus, O and B represent the object or the computer readable variable which holds the value of the object frame and the background frame. In FIG. 14(b), the Action Function G is then passed to an Animation-Action Mapping function which Outputs the Animation Function F(S) where S is the set of attributes required to run the animation. Further, various Artificial Intelligence (AI) techniques may be used for Mapping Action-Animation such as the Karnaugh Map and the like. Hence, F(S) is denoted as follows:

F(S): MovingCarAnimation(S)

Such that,

S={speed, angle, curvature, . . . }

Further, the animation-action mapping function is configured to calculate the most similar Animation function mapped to the input action function, which is given as below:

H(G)˜F

Thus, H(G) gives the most similar Animation Function F corresponding to given Action Function G which is shown in the below table:

TABLE 8
Animation function F corresponding
to given action function G

| Action(F) | Animation(G) |
|---|---|
| F1 | G1 |
| F2 | G2 |
| F3 | G3 |
| F4 | G4 |
| F5 | G5 |
| \| | \| |
| \| | \| |
| \| | \| |
| Fx | Gx |
| \| | \| |
| \| | \| |
| Fn | n |

Further, if an animation F is produced by an action G, then an animation F can also produce an action F−1 which is G. For example, if MovingCarAnimation(F) is produced due to MovingCarAction(G) then MovingCarAction(G) can also produce MovingCarAction2(G′) which would had been MovingCarAction(G). In simple terms, Moving Car animation can produce Moving Car action if Moving Car animation is produced by Moving Car action and vice versa. The action function G (O,A,B) is the inverse of F. Thus, F−1=G. This implies,

If, G→F

Then, F→G

Hence, F↔G

Thus, the Similarity function is the measure of how inverse an animation-action pair is. As shown in FIG. 14(c), in the beginning, the animation-action map would be empty, but the search module 1402 adds new animation function to the map when no similar Animation function is found for a given action as shown in the table below:

TABLE 9
Adding new animation function to the map

| Action (F) | Animation (G) | | Action (F) | Animation (G) |
|---|---|---|---|---|
| F1 | G1 | | F1 | G1 |
| F2 | G2 | | F2 | G2 |
| F3 | G3 | | F3 | G3 |
| F4 | G4 | | F4 | G4 |
| F5 \| \| | G5 \| \| | 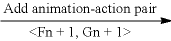 | F5 \| \| | G5 \| \| |
| \| | \| | | \| | \| |
| Fx | Gx | | Fx | Gx |
| \| | \| | | \| | \| |
| \| | \| | | \| | \| |
| Fn | Gn | | Fn | Gn |
| | | | Fn + 1 | Gn + 1 |

For example, there is no action-animation pair in the map for moving car without gravity as such a video has never been processed. Thus, when such an action is detected, the Action Function Gc is created by the video processor module 102. But a similar function Fc is not found in the map. Thus the create module 1404 creates a new Animation Function Fc for this action. As shown in FIG. 14(d), the audio/video is processed by the video processor module (102) and the activity from the video input is mapped with the animation function to give the video output. In FIG. 14(e), the audio/video is fetched as an input to the player application. The file consists of one or more category of instructions to run the animation functions for a given set of object frame and background frame. The animator module 108 is configured to download the animation from the same map and to provide instructions to the player to run it to give a video playback as shown in FIG. 14(f).

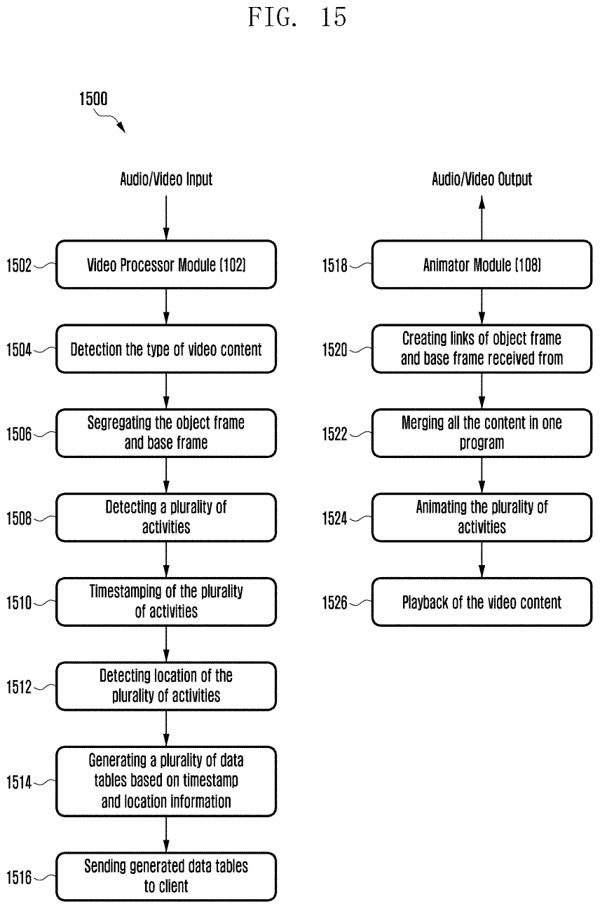

FIG. 15 is a flowchart illustrating a method for animation based encoding, decoding and playback of a video content in a client-server architecture, according to an exemplary implementation of the presently claimed subject matter. The working of the video processor module 102 and the animator module 108 together for the video playback is provided herein. At step 1504, the type of the video content is detected and then one or more object frames and a base frame are detected by an object and base frame detection module from the video content based on one or more related parameters. At step 1506, the detected object frame and the base frame are segregated from the part of the video content by an object and base frame segregation module. Further, at step 1508, a plurality of activities are detected in the object frame by an activity detection module. Further, at steps 1510 and 1512, the timestamp and the location of the plurality of activities are detected by a timestamp module and an object locating module respectively. At step 1514, a plurality of data tables based on the timestamp and location information are generated by a file generation module. At step 1516, these generated data tables are sent to the client device. Further, at step 1520, a plurality of API's corresponding to the plurality of activities are identified and mapped. As soon a request is received for playback of the video content, at step 1522, the animator module merges the plurality of activities with the object frame and the base frame for outputting said formatted video playback (step 1526).

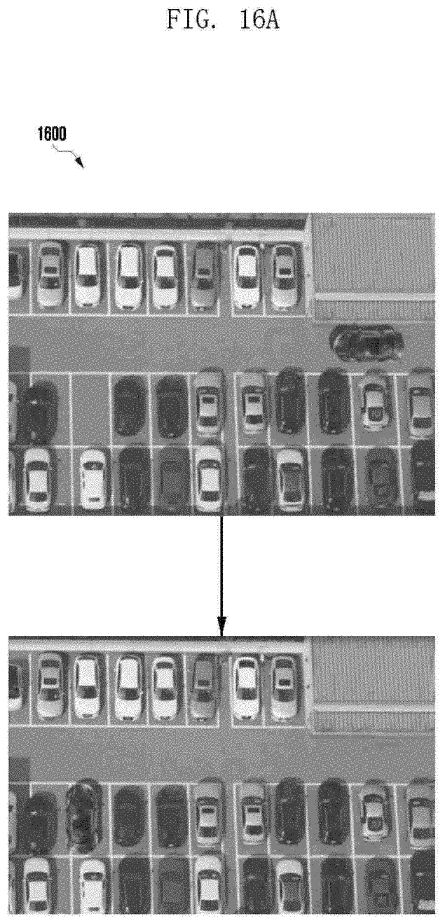

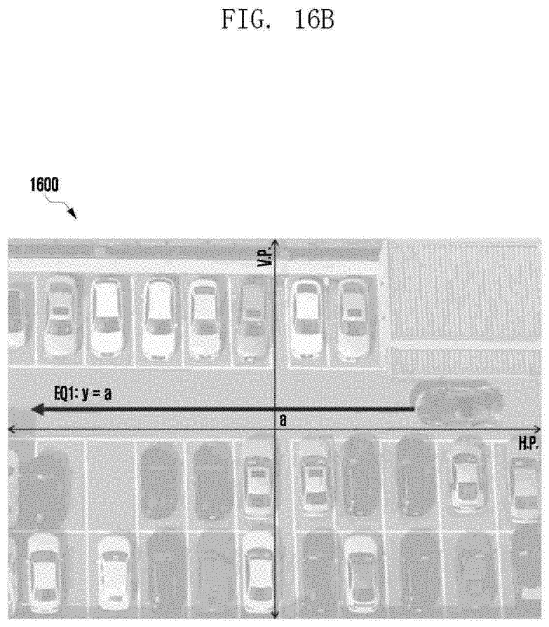

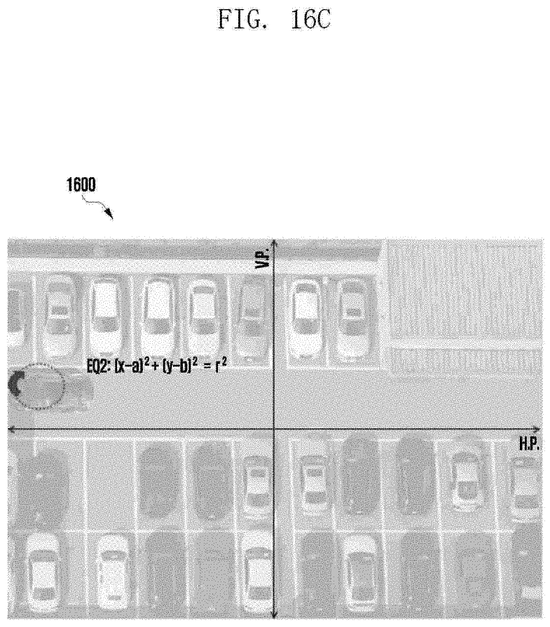

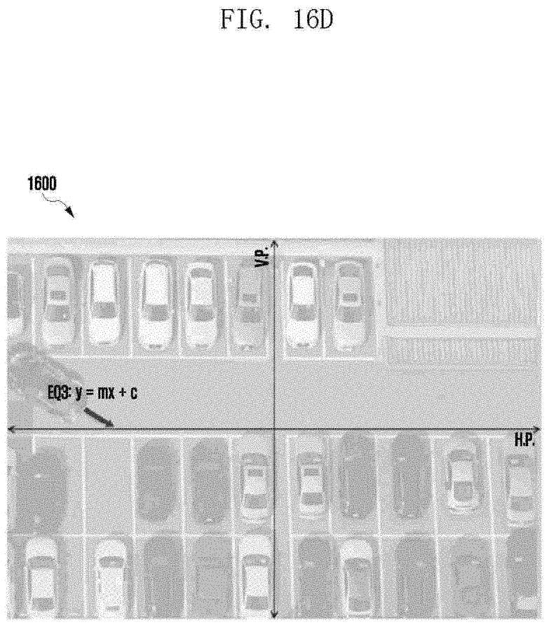

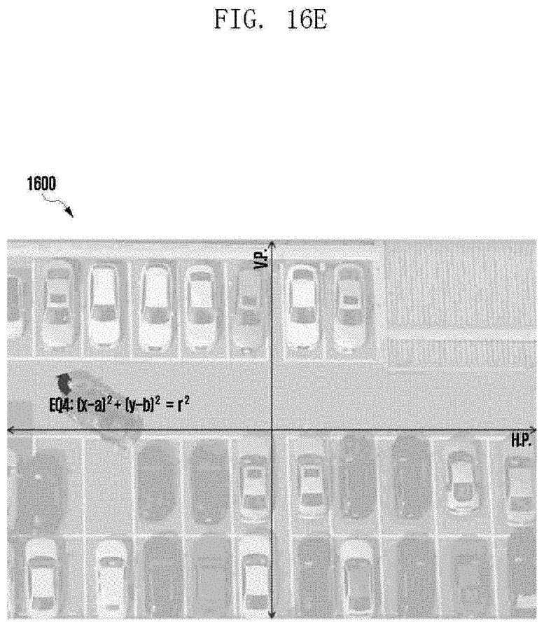

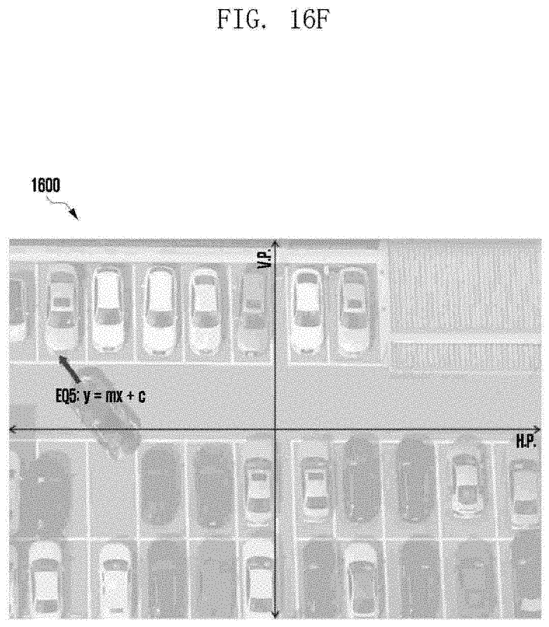

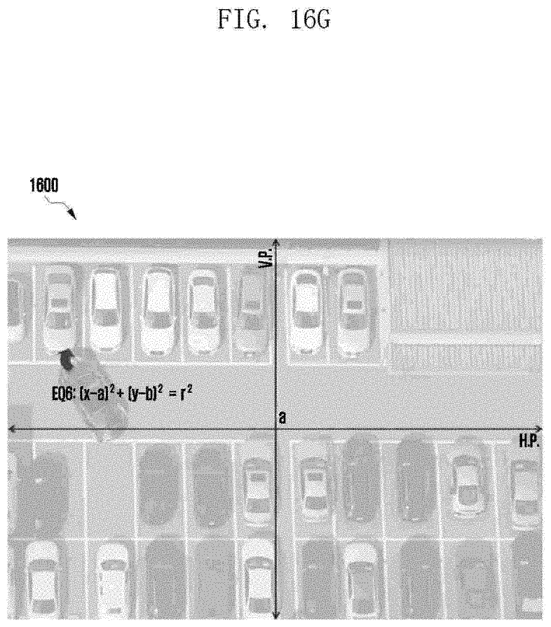

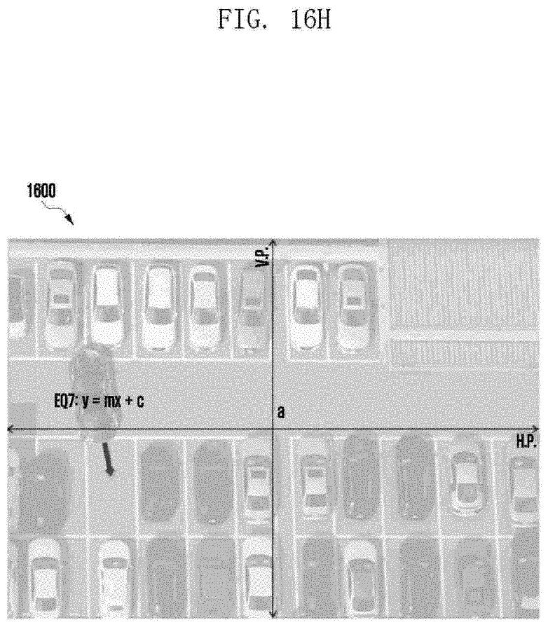

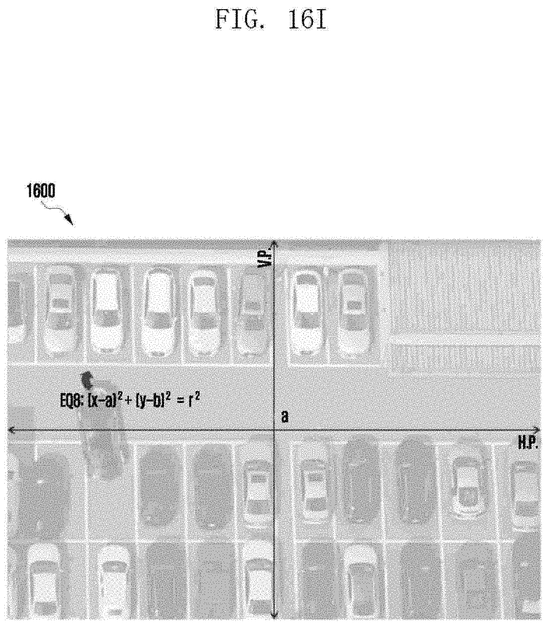

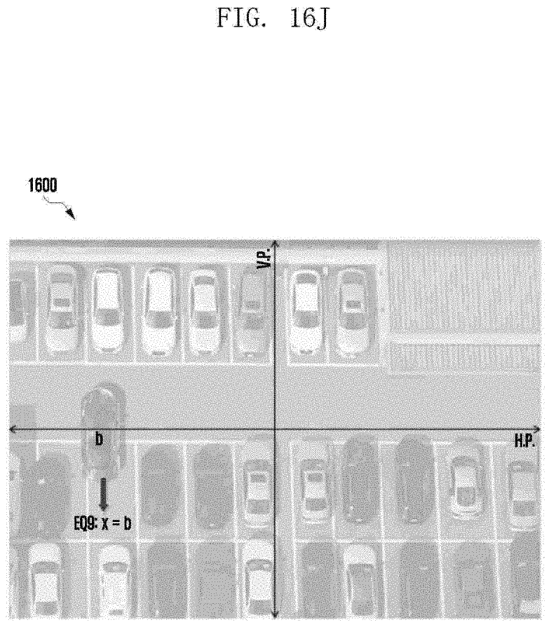

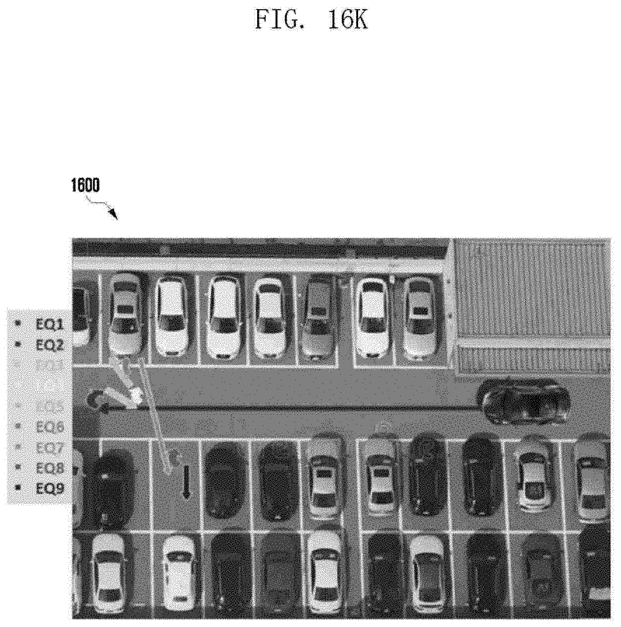

FIGS. 16(a)-16(k) illustrates the creation of action function by analysing the change of the object over the background frame in the video, according to an exemplary implementation of the presently claimed subject matter. In this, we can use AI whose internal processing includes the creation of action function by analysing the change of the object over the background frame in the video. In an exemplary implementation the motion of the car in a parking lot while parking the car in the vacant slot is provided herein. The car may take many linear and rotary motions to get it inside the parking lot. Let us consider,

G: Action function for the motion of the car for parking it,

V.P.: The vertical plane of the background frame, and

H.P.: The horizontal plane of the background frame.

In the FIG. 16(b), the car moves in a straight line to get near the empty parking lot. The traversal in the frame of the parking space could be represented as a straight line as the motion is linear. This motion could thus be represented by:

y=a EQ₁:

where ‘a’ is a constant distance from H.P. As the motion is horizontal and EQ1 is parallel to H.P. After reaching to the parking lot, the car needs to rotate by some angle to adjust the turns as shown in FIG. 16(c). The motion here is a rotary motion. This motion could be represented in a H.P. vs. V.P. graph with the equation of a circle. Thus,

(x−a)₂+(y−b)₂=r₂ EQ2:

where,

a: distance between H.P. and the center of the circle;

b: distance between V.P. and the center of the circle; and

r: radius of the circle

Further, this motion could also be represented by the equation for the arc of the circle. This is given by:

arclength=2πr(ø/360) EQ2′:

where,

r: radius of the arc; and

Ψ: central angle of the arc in degrees

FIG. 16(d) shows that the third motion is moving towards the parking lot in a linear motion but neither parallel to the H.P. or V.P. Such a motion is represented using a special constant m, called the slope of the line. Thus, the motion could be represented by below equation:

y=mx+c EQ3:

where,

m: slope/gradient; and

c: intercept <value of y when x=0>

Further, the other motions shown in FIGS. 16(e), 16(f), 16(g), 16(h), 16(i), 16(j), are similar to the above-mentioned three motions, the equations for which are given below:

(x−a)₂+(y−b)₂=r₂ EQ₄:

y=mx+c EQ5:

(x−a)₂+(y−b)₂=r₂ EQ6:

y=mx+c EQ7:

(x−a)₂+(y−b)₂=r₂ EQ8:

FIG. 16(k), shows the last phase of motion for parking of the car. This motion is parallel to the V.P and it could thus be represented by:

x=b EQ9:

where ‘b’ is a constant distance from V.P. As the motion is horizontal, EQ9 is parallel to V.P. Hence, the action function G is represented as below:

G=EQ1>EQ2>EQ3>EQ4>EQ5>EQ6>EQ7>EQ8>EQ9>null

where,

>: a special type of binary function such that,

If A>B, A happens before B; and

Null marks the end of the function.

Thus, G is the combination of all the motions that had taken place. Further, the animation function F as discussed above is used while playing the video. During the search, the action functions are generated with the help of the animation function. The action functions similar to the occurred action is received by the video processor module. It is the decision of the video processor module either to map the action to animation API or create a new animation API corresponding to the action occurred if there is no similarity.

In the example above, the animation-action map stores the linear and the rotary motions of the car. Thus, many action functions would be downloaded until all these types of motion functions are obtained i.e. from <EQ1 to EQ9>. The set of similar functions are downloaded until all of EQ1 to EQ9 are found. In case any of the motion function is not found, then the action function's animation function is created and added into the map, which is shown in the below table:

TABLE 10
Activity-Animation similarity

| Action Functions | Similar Action Functions | Similarity |
|---|---|---|
| G = | G1: EQ1 > EQ4 | 2/9 |
| EQ1 > EQ2 > EQ3 > EQ4 > | G2: EQ3 > EQ10 | 2/9 |
| EQ5 > EQ6 > EQ7 > | G3: EQ4 > EQ5 > EQ2 | 3/9 |
| EQ8 > EQ9 > null | G4: EQ9 | 1/9 |
| | G5: EQ2 > EQ3 > EQ4 > EQ11 > EQ12 > EQ13 | 3/9 |
| | G6: EQ1 | 1/9 |
| | G7: EQ6 > EQ7 > EQ8 | 3/9 |
| | G8: FQ1 > EQ9 | 2/9 |

Thus,

G=G1∪G2∪G3∪G4∪G7 Or G3∪G5∪G7∪G8.

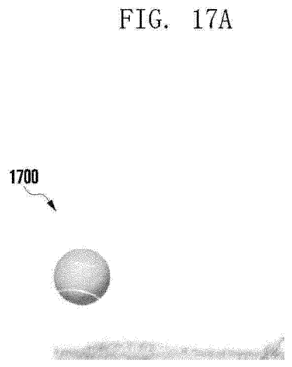

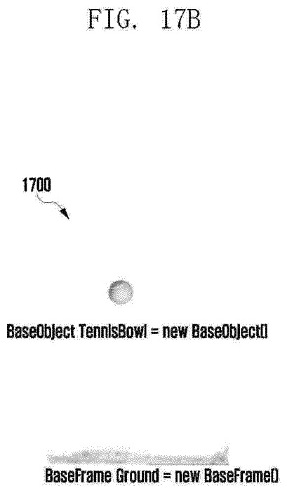

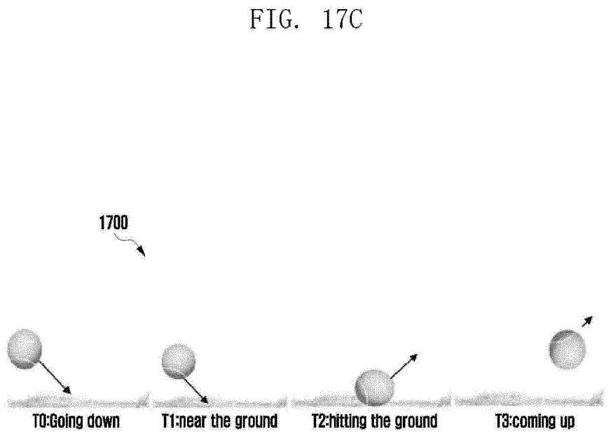

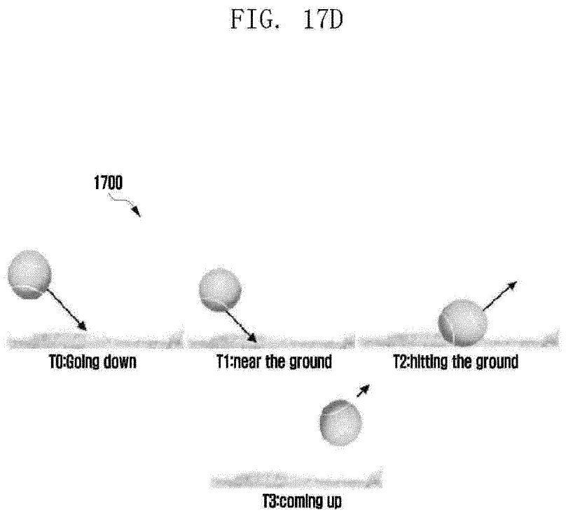

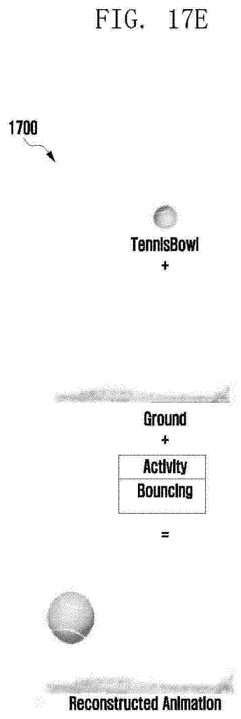

FIG. 17(a)-17(e) illustrates a used case of a low sized video playback of a bouncing ball, according to an exemplary implementation of the presently claimed subject matter. FIG. 17(a) is a pictorial implementation illustrating the detection of the object frame and the background frame, according to an exemplary implementation of the invention. FIG. 17(b) is a pictorial implementation illustrating the segregation of the object frame and the background frame, according to an exemplary implementation of the invention. FIG. 17(c) is a pictorial implementation illustrating the timestamping of the plurality of activities, according to an exemplary implementation of the invention. FIG. 17(d) is a pictorial implementation illustrating the detection of the location of the plurality of activities, according to an exemplary implementation of the invention. FIG. 17(e) is a pictorial implementation illustrating the merging of the plurality of activities with the object frame and the base frame for outputting a formatted video playback, according to an exemplary implementation of the invention. The video playback of the bouncing of a ball is provided herein. Here, the ball and the background which is the ground are segregated. The action of the ball which is bouncing is triggered. The timestamp and the location of the bounce of the ball is obtained and stored. The action of bouncing matches to the BouncingBall( ) animation in the API cloud and this API is downloaded at the player side. Further, the video playback is obtained by animating the ball, which is the object, with the BouncingBall( ), which is the animation API, and the ground, which is the background frame, with the obtained time and location details. Firstly, the scene is detected wherein the bouncing ball, the tennis court and outdoors are detected. Now, only the bouncing ball is partitioned from the video. The object, which is the ball and the background frame, which is the ground, are detected. Further, the object, which is the ball and the background frame, which is the ground, are segregated. Further, in the next step of object segregation, no foreign objects are detected. Further, the activity of bouncing of ball is detected. Further, no foreign activities are detected during the activity segregation step. Further, timestamps of the bouncing ball i.e. T0, T1, T2, and T3 and the location of the bouncing ball i.e. L0, L1, L2 and L3, are obtained. The animation API which is the BouncingBall( ) API is downloaded. Finally, the object which is the ball, the background frame which is the ground and the animation API which is the BouncingBall( ) are merged together to animate the video playback.

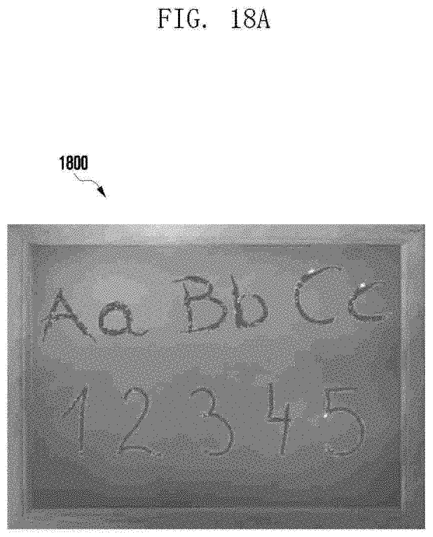

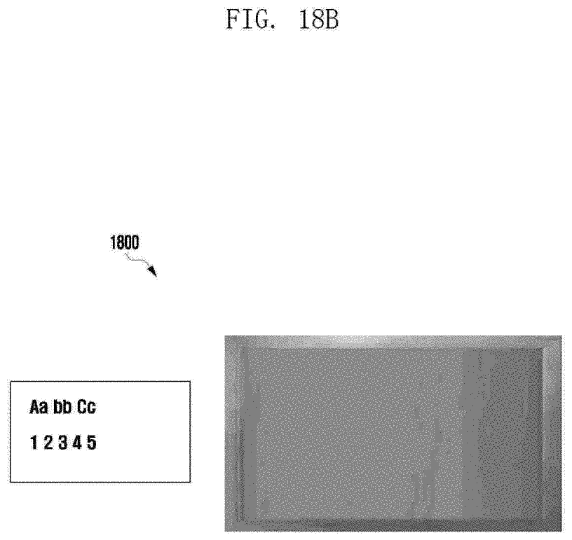

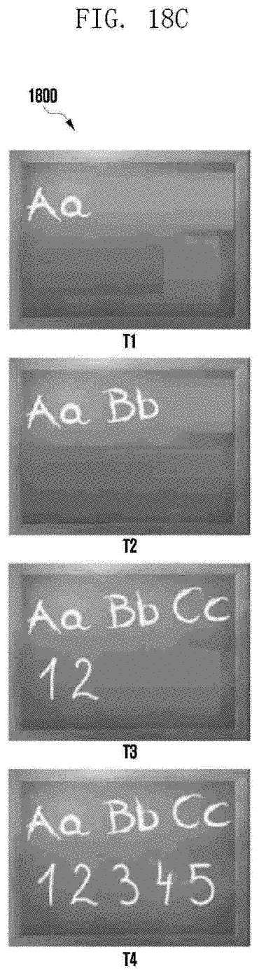

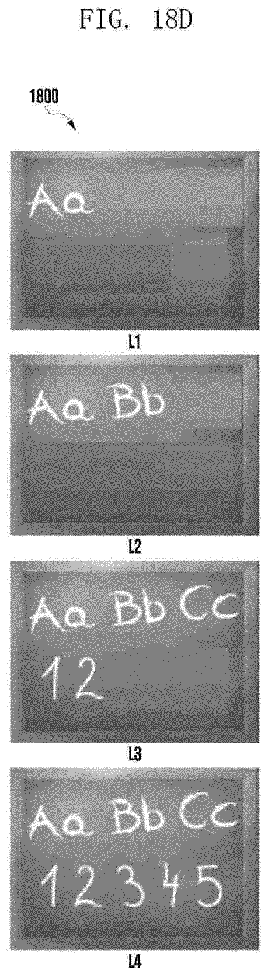

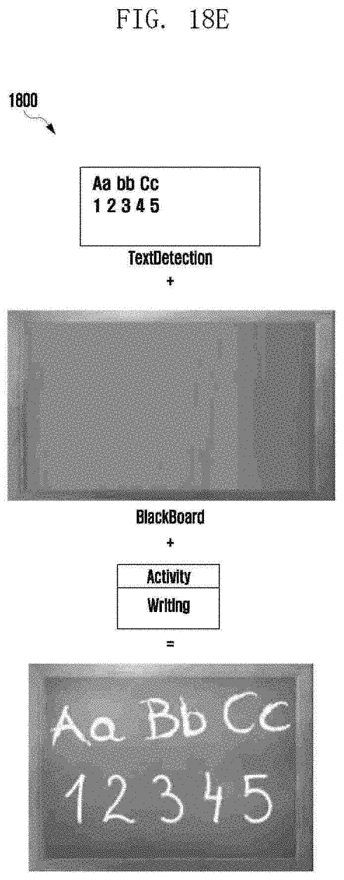

FIG. 18(a)-18(e) illustrates a used case of a low sized video playback of a blackboard tutoring, according to an exemplary implementation of the invention. FIG. 18(a) is a pictorial implementation illustrating the detection of the object frame and the background frame, according to an exemplary implementation of the invention. FIG. 18(b) is a pictorial implementation illustrating the segregation of the object frame and the background frame, according to an exemplary implementation of the invention. FIG. 18(c) is a pictorial implementation illustrating the timestamping of the plurality of activities, according to an exemplary implementation of the invention. FIG. 18(d) is a pictorial implementation illustrating the detection of the location of the plurality of activities, according to an exemplary implementation of the invention. FIG. 18(e) is a pictorial implementation illustrating the merging of the plurality of activities with the object frame and the base frame for outputting a formatted video playback, according to an exemplary implementation of the invention. The video playback of a tutorial in class is provided herein. Here, the Text(Aa bb Cc \ 1 2 3 4 5) and the background which is the Black Board are segregated. The action of the text which is writing over the board is triggered. The timestamp and the location of text being written is obtained and stored. The action of writing matches to WritingOnBoard( ) animation in the API cloud and this API is downloaded at the player side. Further, the video playback is obtained by animating the text, which is the object, with the WritingOnBoard( ), which is the animation API, and the Black Board, which is the background frame, with the obtained time and location details. Firstly, the scene is detected wherein the classroom, teacher, teaching and the mathematics class are detected. Now, only the teach differentiation is partitioned from the video. The object, which is the text i.e. “Aa bb Cc \n 1 2 3 4 5”, and the background frame, which is the blackboard, both are detected. Further, the object, which is the text and the background frame, which is the blackboard, are segregated. Further, in the next step of object segregation, no foreign objects are detected. Further, the activity of writing on board is detected. Further, no foreign activities are detected during the activity segregation step. Further, timestamps of the writing on board i.e. T0, T1, T2, and T3 and the location of the writing on board i.e. L0, L1, L2 and L3, are obtained. The animation API which is the WritingonBoard( ) API is downloaded. Finally, the object which is the text, the background frame which is the blackboard and the animation API which is the WritingonBoard( ) are merged together to animate the video playback.

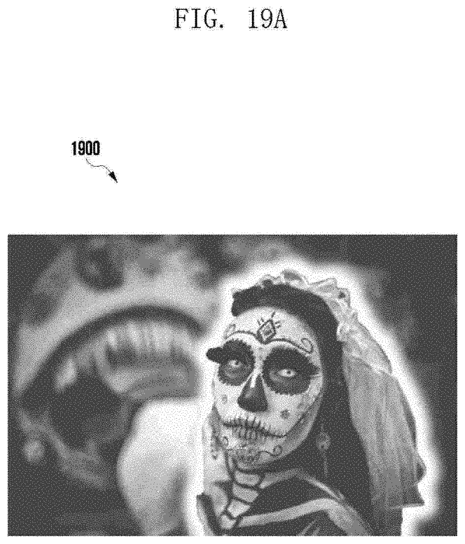

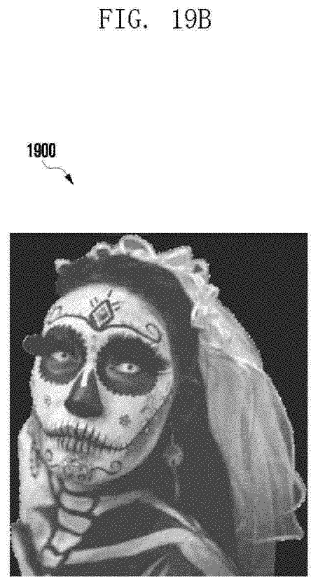

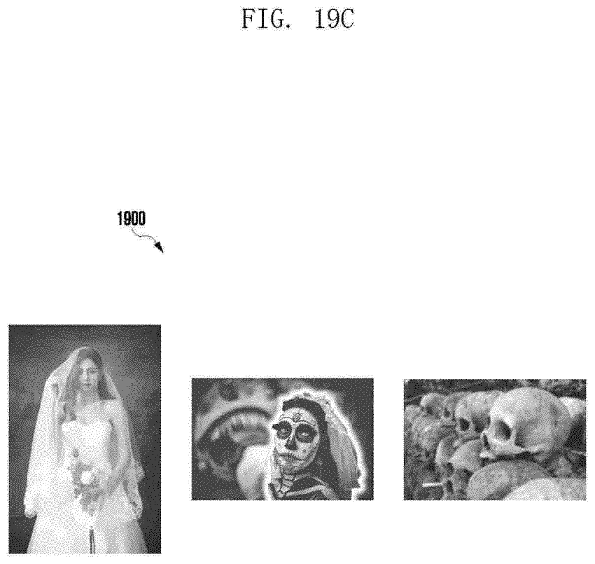

FIG. 19(a)-19(c) is illustrating the enhancement of a user experience while watching a video, according to an exemplary implementation of the invention. FIGS. 19(a), 19(b) and 19(c) is a pictorial implementation that illustrates the identifying of a cast description in the video content, according to an exemplary implementation of the invention. As the video is more of a program rather than just a succession of frames, the program is made more interactive to improve user experience. Here, the user would want to know everything about an object in the video. This object could be an actor casting a role in a movie. Thus, the cast description can be obtained by clicking on the cast. The cast description is obtained from the video with the physical data which are all the object traits exhibited by the cast like shape, colour, structure, etc. and behavioural data which are all the activities done by the cast like fighting, moving, etc. This data is stored in the database while the video processing is done. In this FIG. 19(b), the object traits exhibited by Blood-Bride are: physical data: women, long hair, deadly eyes, and the like and the behavioural data: killer, deadly, witch, ghostly, murderer, and the like. Further, the physical data is obtained by detecting the object with the object code and the behavioural data is obtained by considering the activities done by the object in the video. The activities done by blood-bride are wedding, death and kill and turn people to ghost as shown in FIG. 19(c).

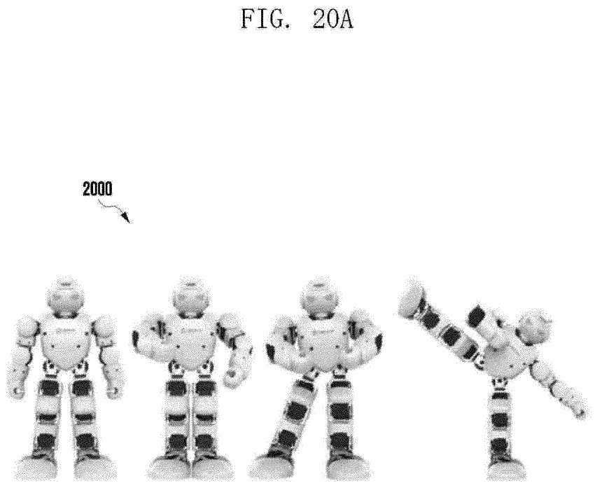

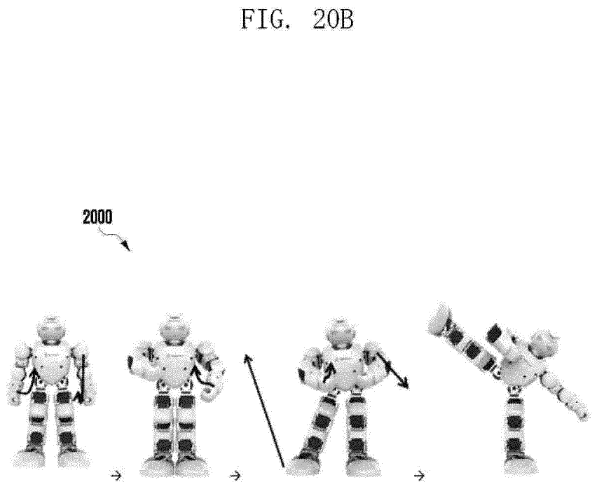

FIG. 20(a)-20(b) is illustrating the recognition of new set of activities and storing them in the API cloud, according to an exemplary implementation of the invention. FIG. 20(a) is a pictorial implementation illustrating the detection of a new action in the video content, according to an exemplary implementation of the invention. FIG. 20(b) is a pictorial implementation that illustrates the obtaining of animation from the detected new action in the video content, according to an exemplary implementation of the invention. Identifying new set of activities and storing them in the API cloud is provided herein, wherein the new set of activities can be created using AI techniques. For example, a new activity which is a kick made by a robot is detected for the first time as shown in FIG. 20(a). Such an activity had never been encountered in a video ever. This activity is analysed as shown in FIG. 20(b). The photo 1 is a left hand positioned to chest and right hand approaching. The photo 2 is a right hand positioned to chest and legs brought together. The photo 3 is a left leg set for kick with both hands near the chest and photo 4 is a left side kick with left hand still on the chest and right hand straightened for balance. Thus, an animation is built with the activities performed as above.

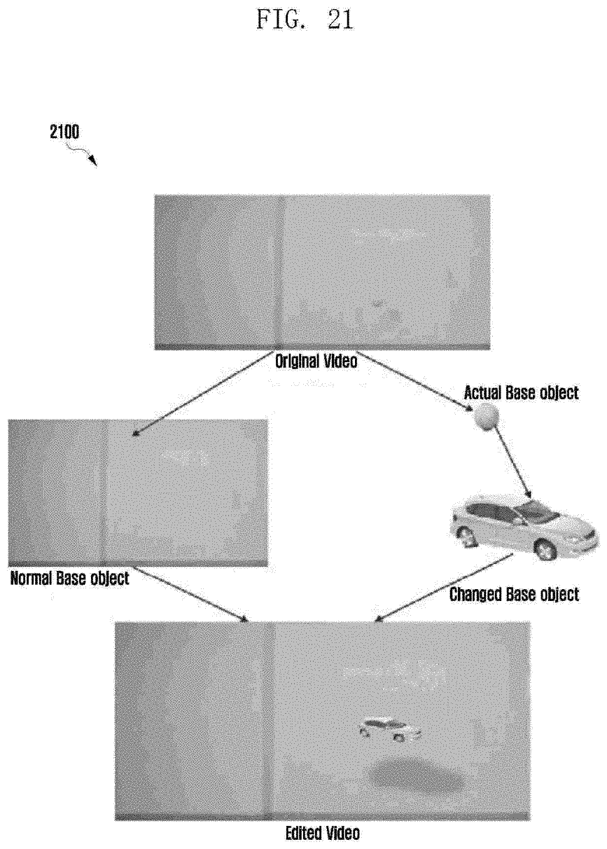

FIG. 21 is a pictorial implementation of a used case illustrating the editing of a video with relevance to a new changed object, according to an exemplary implementation of the invention. In the processed video, since the object has got segregated and was stored in the form of variables one could easily change these variables. The database of the activity table with the base frame and object can be modified. Moreover, the attributes of the present objects can be copied with relevance to the new changed object. And thus a car, which is the changed base object, can do the action of a bouncing ball, which is the actual base object, on the given normal base frame. The object behaviours like shadow is copied and the activity ‘bounce’ is copied with the object ‘car’.

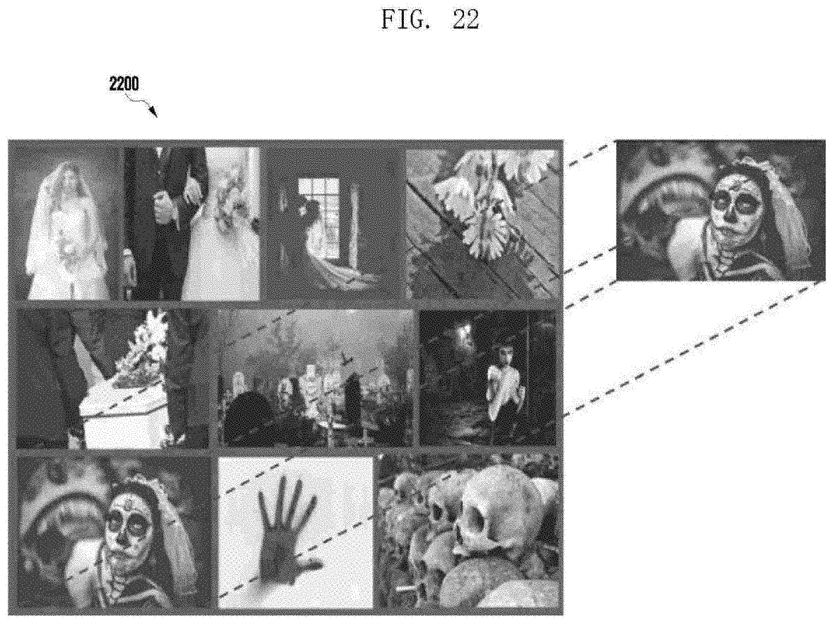

FIG. 22 is a pictorial implementation of a used case illustrating a trailer making from a whole movie clip, according to an exemplary implementation of the invention. The use of .vdo format is also extended to movie making. Since all the details of the video are available, many utilities could be done upon it. Here, all data of a multimedia activities, objects and background details are present and thus the trailer making part is possible. The important scenes of a movie can be extracted such as the wedding, death and killing are used to make a trailer. The frame shown in FIG. 22 captures an important scene where the bride turns into a ghost. This scene could be included in the trailer.

In another exemplary embodiment, match highlights can be made by analysing the frequencies of the video and sound waves. Further, the data related to the game is obtained which is most important. For example, a football goal kick could be kept in the highlights.

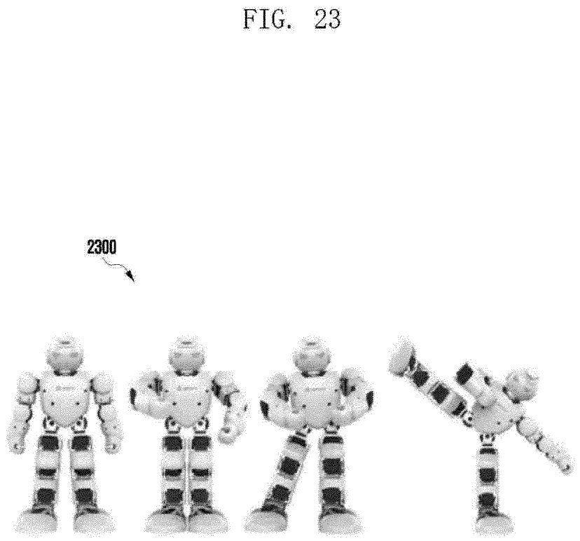

FIG. 23 is a pictorial implementation of a used case illustrating the processing of detected activities by an electronic device, according to an exemplary implementation of the invention. The detected activities can be processed by an electronic device to perform certain action on the trigger of this activity. For example, in an alarm system, on detection of any dangerous activity, an alarm could be installed to detect such systems. Further, in an activity assistant system such as dance tutor or gym tutor, since the activity is concisely detected by the machine, the activity assistant could be modelled for the purpose of learning that activity. A gym posture, a dance step, a cricket shot, a goal kick, etc. could be the precious output. Further, as shown in this figure, a robot is desired to carry out all the activities that a human can. To determine these activities, the activities obtained from a video could serve the purpose. A module that converts these activities to robotic signals could process this activity mainly based on angle, speed, orientation, etc. and apply it to the robotic components (servo motors, sensors, etc.) in order to perform the activity detected in the video.

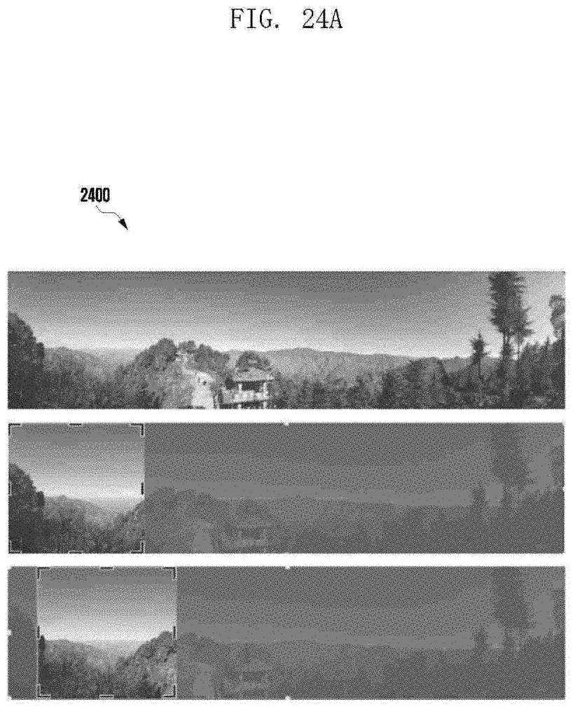

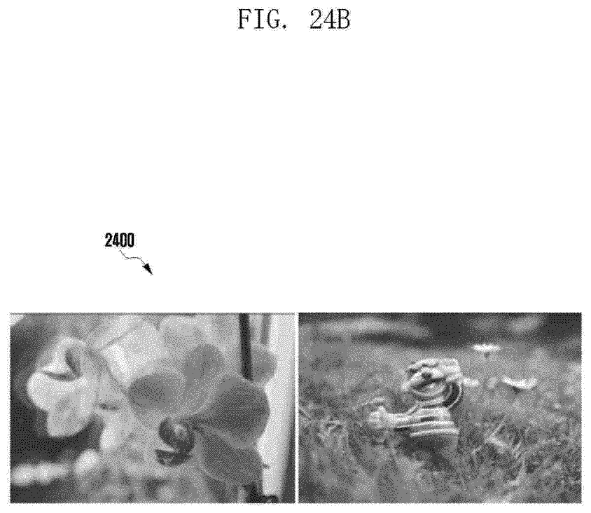

FIG. 24(a) is a pictorial implementation of a used case illustrating the frame by frame processing of a panoramic video, according to an exemplary implementation of the invention. For a 360 or a panoramic video, the same processing part frame by frame is used. Apart from this, panorama can be used in a normal video to get the base frame where the video frames are moving in panoramic directions i.e. <circular/left-right/curve>. A 360 video can be used for getting an all direction base frame.

FIG. 24(b) is a pictorial implementation of a used case illustrating the frame by frame processing of a 3D video, according to an exemplary implementation of the invention. To make a 3D video frame by frame analysis is done to get the depth of the objects. This part is already done in a .vdo format video. Thus, the overhead is removed. In another exemplary implementation, .vdo format for 4D videos is explained. 4D video is guided by physical entities present in a video and avail the same with real physical entity. The part of detecting the physical entity of the video like air, water, weather, vibrations, etc. is done mostly manually. Thus, this part is already covered in a .vdo format file. To produce rain effect one has to keep water at the tip of the theatre. But the amount of water that would be required can be generated in a .vdo format. A complete automation system of this could thus be built.

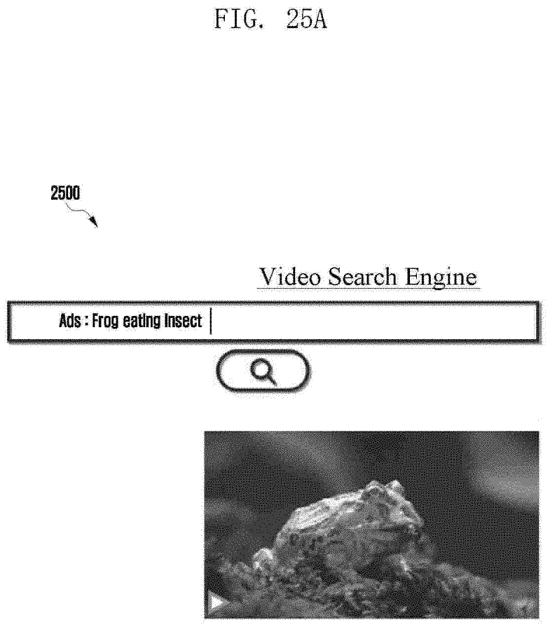

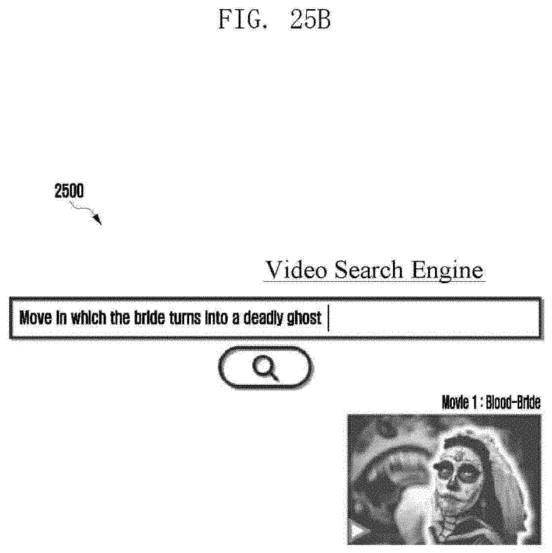

FIG. 25(a)-25(b) is illustrating the expansion of the video search engine search space, according to an exemplary implementation of the invention. FIG. 25(a) is a pictorial implementation illustrating the video search engine based on video activity database, according to an exemplary implementation of the invention. FIG. 25(b) is a pictorial implementation illustrating an advanced video search engine, according to an exemplary implementation of the invention. Here, the video content itself serves the data required as the video content has the detail of itself within. For example, if an episode in which something specific happens is to be searched for, then the episode can be fetched easily as all activities are stored already. In this, a video format in which video is descriptive about itself is provided. Hence, the association with heavy metadata is avoided. This scenario is analysed with dataset of an episode about the blood-bride's wedding. Further, when such a movie is processed, the video data part is stored as below:

Scene1: Wedding of Blood bride:

Part1:

time <actor, action, base frame>

T0<bride, gets ready, wedding set>

T1<bride, listening to wedding prayers, wedding set>

Part 2:

T2<bridegroom, holds hand, wedding set>

T3<bridegroom, dies, wedding set>

Scene 2: Killing by blood bride:

Part3:

time <actor, action, base frame>

Tx <bride, dies, wedding set>

Ty <bride, becomes ghost, wedding set>

Part 2:

Tz <bride, kills X bride's bridegroom, X's wedding set>

The actors of the scene are detected and their physical and behavioral data traits are obtained. Further, the present invention provides a very refined and advanced video search engine, wherein even if the movie name is not known, the search could still return a relevant result.

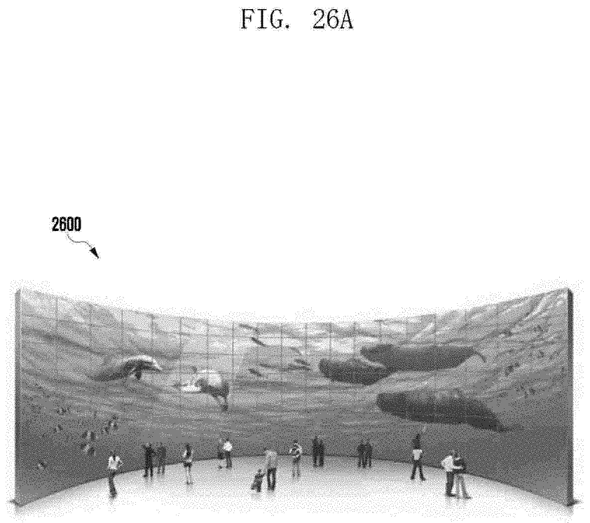

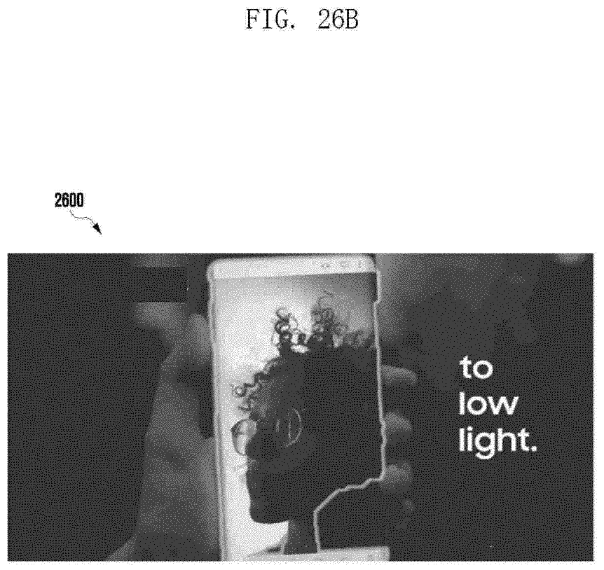

FIG. 26(a) is a pictorial implementation of a used case illustrating the usage of the proposed system on a Large Format Display (LFD), according to an exemplary implementation of the invention. FIG. 26(b) is a pictorial implementation of a used case illustrating a LFD displaying an interactive advertisement, according to an exemplary implementation of the invention. Here, the .vdo format can be used in an LFD. In a food joint, it can be used to click and check all specifications in terms of food content, spices, ingredients, etc. of any food item. It can also be used to display interactive advertisements. It can also be used to display environment scenarios like underwater, space, building planning, bungalow furnishing, fun park/waterpark description, etc. Further, it can be used as an artificial mirror capable of doing more than just display image. The image of the person in the mirror can be changed to some great actor and the movements of the person can be reflected as done by the actor.

In FIG. 26(b), an LFD displays an ad of a mobile phone can be made more interactive. The additional details can be embedded in an object for the purpose of detailing the object to the highest extent. Here, the object behaviour of the mobile phone is obtained first. However, it is not possible to obtain data like RAM, Camera, Processor, etc. just by detecting the phone. Thus, the internals of this must be filled. These external details could be fetched from the web or from manually.

It should be noted that the description merely illustrates the principles of the present invention. It will thus be appreciated that those skilled in the art will be able to devise various arrangements that, although not explicitly described herein, embody the principles of the present invention. Furthermore, all the used cases recited herein are principally intended expressly to be only for explanatory purposes to help the reader in understanding the principles of the invention and the concepts contributed by the inventor(s) to furthering the art and are to be construed as being without limitation to such specifically recited used cases and conditions. Moreover, all statements herein reciting principles, aspects, and embodiments of the invention, as well as specific examples thereof, are intended to encompass equivalents thereof.

1. A method for encoding, decoding and playback of a video content in a client-server architecture, the method comprising:
processing, by a video processor module, the video content for dividing said video content into a plurality of parts based on one or more category of instructions;
detecting, by an object and base frame detection module, one or more object frames and a base frame from the plurality of parts of the video content based on one or more related parameters;
segregating, by an object and base frame segregation module, the object frame and the base frame from the plurality of parts of the video content based on the related parameters;
detecting, by an activity detection module, a plurality of activities in the object frame;
storing, in a second database, the object frame, the base frame, the plurality of activities and the related parameters;
identifying and mapping, by an activity updating module, a plurality of API's corresponding to the plurality of activities based on the related parameters;
receiving, by a server, a request for playback of the video content from one of a plurality of client devices; and
merging, by an animator module, the plurality of activities with the object frame and the base frame for outputting a formatted video playback based on the related parameters.

2. The method as claimed in claim 1, wherein processing, by the video processor module, the video content for dividing said video content into the plurality of parts based on one or more category of instructions, further comprises:
processing, by the video processor module , the received video content;
detecting, by a scene detection module, one or more types of the video content;
applying, by a first database, one or more category of instructions on a type of the video content; and
dividing, by a video division module, the video content into the plurality of parts based on the one or more category of instructions from the first database.

3. The method as claimed in claim 1, further comprises:
identifying, by the activity updating module, a plurality of unknown activities;
creating, by the activity updating module, a plurality of API's for the plurality of unknown activities; and
mapping, by the activity updating module, the created plurality of API's with the plurality of unknown activities.

4. The method as claimed in claim 1, wherein processing, by the video processor module, for dividing said video content into the plurality of parts based on one or more category of instructions, further comprises:
extracting, by the video processor module, the related parameters of the object frames from the video content.

5. The method as claimed in claim 1, wherein the identifying and mapping, by the activity updating module, the plurality of API's corresponding to the plurality of activities further comprises:
storing, by a timestamp module, a plurality of timestamps corresponding to the plurality of activities;
storing, by an object locating module, a plurality of location details and an orientation of a relevant object corresponding to the plurality of activities; and
generating and storing, by a file generation module, a plurality of data tables based on the timestamp and location information.

6. The method as claimed in claim 1, further comprises:
storing, in the second database, an additional information corresponding to the object frame;
detecting an interaction input on the object frame during playback of the video content; and
displaying the additional information along with the object frame.

7. The method as claimed in claim 1, wherein a first database is a video processing cloud, and wherein the video processing cloud further comprises:
providing instructions related to the detecting of a scene from the plurality of parts of the video content to the video processor module;
determining the instructions for providing to each of the plurality of parts of the video content;
assigning each of the plurality of parts of the video content to the server, wherein said server provides the instructions; and
providing a buffer of instructions for downloading at the server.

8. A system for encoding, decoding and playback of a video content in a client-server architecture, the system comprising:
a video processor module configured to process the video content to divide said video content into a plurality of parts based on one or more category of instructions;
an object and base frame detection module configured to detect one or more object frames and a base frame from the plurality of parts of the video content based on one or more related parameters;
an object and base frame segregation module configured to segregate the object frame and the base frame from the plurality of parts of the video content based on the related parameters;
an activity detection module configured to detect a plurality of activities in the object frame;
a second database configured to store the object frame, the base frame, the plurality of activities and the related parameters;
an activity updating module configured to:
identify a plurality of API's corresponding to the plurality of activities based on the related parameters; and
map the plurality of API's corresponding to the plurality of activities based on the related parameters; and
a server configured to receive a request for playback of the video content from one of a plurality of client devices; and
an animator module configured to merge the plurality of activities with the object frame and the base frame for outputting a formatted video playback based on the related parameters.

9. The system as claimed in claim 8, wherein the video processor module configured to process the video content to divide said video content into the plurality of parts based on one or more category of instructions, further comprises:
the video processor module configured to process the received video content;
a scene detection module configured to detect one or more types of the video content;
a first database configured to apply one or more category of instructions on a type of the video content; and
a video division module configured to divide the video content into the plurality of parts based on the one or more category of instructions from the first database.

10. The system as claimed in claim 8, wherein the video processor module configured to divide said video content into the plurality of parts based on one or more category of instructions, further comprises:
video processor module configured to extract the related parameters of the object frames from the video content.

11. The system as claimed in claim 8, wherein the object and base frame detection module configured to detect one or more object frames and a base frame further comprises:
an object segregation module configured to detect a foreign object and a relevant object from the object frame.

12. The system as claimed in claim 8, wherein the activity detection module configured to detect the plurality of activities in the object frame further comprises:
an activity segregation module configured to segregate the plurality of activities that are irrelevant in the video content.

13. The system as claimed in claim 8, wherein the activity updating module configured to identify and map the plurality of API's corresponding to the plurality of activities further comprises:
a timestamp module configured to store a plurality of timestamps corresponding to the plurality of activities;
an object locating module configured to store a plurality of location details and an orientation of a relevant object corresponding to the plurality of activities; and
a file generation module configured to generate and store a plurality of data tables based on the timestamp and location information.

14. The system as claimed in claim 8, wherein the activity updating module configured to identify and map the plurality of API's corresponding to the plurality of activities is based on related parameters, wherein the related parameters includes the API, the object frame, the base frame, the activity performed by the object on the base frame and the like.

15. The system as claimed in claim 8, wherein,
the second database is configured to store an additional information corresponding to the object frame;
the object and base frame detection module is configured to detect an interaction input on the object frame during playback of the video content; and
the one client device configured to display the additional information along with the object frame.
